(19) United States
(12) Patent Application Publication
(10) Pub. No.: US 2022/0006292 A1
(43) Pub. Date: Jan. 6, 2022

(54) POWER SYSTEM DISPATCHING METHOD CONSIDERING VOLTAGE SENSITIVE LOAD RESERVE

(71) Applicants: TSINGHUA UNIVERSITY, BEIJING (CN); STATE GRID BEIJING ELECTRIC POWER COMPANY, BEIJING (CN)

(72) Inventors: Bin WANG, BEIJING (CN); Haoran YU, BEIJING (CN); Hongbin SUN, BEIJING (CN); Zijin LI, BEIJING (CN); Qinglai GUO, BEIJING (CN); Cunping WANG, BEIJING (CN); Zhaoguang PAN, BEIJING (CN); Yifan SONG, BEIJING (CN); Xingtao TIAN, BEIJING (CN)

(21) Appl. No.: 17/332,682

(22) Filed: May 27, 2021

(30) Foreign Application Priority Data
Jul. 2, 2020 (CN) 202010625594.0

(51) Int. Cl. H02J 3/24; H02J 13/00; G05B 13/04

(52) U.S. Cl. CPC H02J 3/24; H02J 2203/20; G05B 13/042; H02J 13/00002

(57) ABSTRACT

A power system dispatching method considering voltage sensitive load reserve is provided, with which a power system dispatching model constituted by a ground state operating point model of the power system, an evaluation model of the voltage sensitive load regulation range and an optimization objective of power system dispatch is established, by solving the power system dispatching model, a power system dispatching solution considering voltage sensitive load reserve is obtained.

### CROSS-REFERENCE TO RELATED APPLICATION

This application claims priority to Chinese Patent Application No. 202010625594.0, filed Jul. 2, 2020, the entire disclosure of which is incorporated herein by reference.

### FIELD

The present disclosure relates to the operation control technology of a power system, and more particularly to a power system dispatching method considering voltage sensitive load reserve.

### BACKGROUND

In order to deal with the active power fluctuation effectively, the power system usually reserves a certain amount of power generation capacity for upward or downward adjustment, so as to ensure the active power balance and frequency stability of the power system. As the voltage sensitive load has a certain regulation capability, it can be regarded as a supplement to the active power reserve capacity of the generator to help the power system regulate the active power.

When the voltage sensitive load is used as reserve, it faces the following two problems: 1) How to select the voltage setting value of the current operating point to ensure that the voltage sensitive load has a certain adjustment range while maximizing the sales revenue of the current power system; 2) How to manage the impact of the voltage sensitive load invested in the future as the reserve on the sales revenue. In order to solve these problems, it needs to propose a power system dispatching method considering voltage sensitive load reserve.

### SUMMARY

Embodiments of the present disclosure seek to solve at least one of the problems existing in the related art to at least some extent.

An objective of the present disclosure is to propose a power system dispatching method considering voltage sensitive load reserve, which aims at increasing the reserve capacity of the power system by utilizing the regulation ability of voltage sensitive load effectively. According to embodiments of the present disclosure, a power system dispatching model is established, which is constituted by a ground state operating point model of the power system, an evaluation model of the voltage sensitive load regulation range and an optimization objective of power system dispatch, by solving the power system dispatching model, a power system dispatching solution considering voltage sensitive load reserve is obtained.

In a first aspect of embodiments of the present disclosure, there is provided a power system dispatching method considering voltage sensitive load reserve, including:

(1) establishing a ground state operating point model of a power system:

(1-1) establishing a variable set Q of the ground state operating point model of the power system:

Ω={Pᵢ_{_{G}}_{,t}^{G},rᵢ_{_{G}}_{,t}^{G,u},rᵢ_{_{G}}_{,t}^{G,d},Qᵢ_{_{G}}_{,t}^{G},P_{i,t}^{p f},Q_{i,t}^{p f},U_{i,t}^{p f},δ_{i,t}^{p f},I_{ij,t}^{p f},P_{i,t}^{L},Q_{i,t}^{L},L_{i,t}},

where i_{G} is a serial number of a generator, t is a dispatching time point, Pᵢ_{_{G}}_{,t}^{G} is active power of the generator i_{G} at the dispatching time point t, rᵢ_{_{G}}_{,t}^{G,u} is an upward reserve capacity supplied by the generator i_{G} at the dispatching time point t, rᵢ_{_{G}}_{,t}^{G,d} is a downward reserve capacity supplied by the generator i_{G} at the dispatching time point t, Qᵢ_{_{G}}_{,t}^{G} is reactive power of the generator i_{G} at the dispatching time point t, i is a serial number of a node, P_{i,t}^{p f} is active power injected at the node i at the dispatching time point t, Q_{i,t}^{p f} is reactive power injected at the node i at the dispatching time point t, U_{i,t}^{p f} is a voltage magnitude of the node i at the dispatching time point t, δ_{i,t}^{p f} is a voltage phase angle of the node i at the dispatching time point t, j is a serial number of a node connected to the node i, I_{ij,t}^{p f} is a current in a power line between the node i and the node j at the dispatching time point t, P_{i,t}^{L} is active power of a load at the node i at the dispatching time point t, Q_{i,t}^{L} is reactive power of the load at the node i at the dispatching time point t, and L_{i,t} is a voltage stability index of the node i at the dispatching time point t;

(1-2) establishing a constraint on the active power of the generator:

Pᵢ_{_{G}}^{G,min}≤Pᵢ_{_{G}}_{,t}^{G}≤Pᵢ_{_{G}}^{G,max},•i_{G}∈I^{G},t∈[1,T]

where Pᵢ_{_{G}}^{G,min} is a lower limit of the active power of the generator i_{G}, Pᵢ_{_{G}}^{G,max} is an upper limit of the active power of the generator i_{G}, I^{G} is a set constituted by all the generators, and T is the total number of dispatching time points;

(1-3) establishing constraints on a reserve capacity and a ramp rate of the generator:

0≤rᵢ_{_{G}}_{,t}^{G,u}≤Pᵢ_{_{G}}^{G,max}−Pᵢ_{_{G}}_{,t}^{G},∀i_{G}∈I^{G},t∈[1,T]

0≤rᵢ_{_{G}}_{,t}^{G,d}≤Pᵢ_{_{G}}_{,t}^{G}−Pᵢ_{_{G}}^{G,min},∀i_{G}∈I^{G},t∈[1,T]

(Pᵢ_{_{G}}_{,t}^{G}+rᵢ_{_{G}}_{,t}^{G,u})−(Pᵢ_{_{G}}_{,t+1}^{G}−rᵢ_{_{G}}_{,t+1}^{G,d})≤Rᵢ_{_{G}}^{G,d},∀i_{G}∈I^{G},∀t∈[1,T−1]

(Pᵢ_{_{G}}_{,t+1}^{G}+rᵢ_{_{G}}_{,t+1}^{G,u})−(Pᵢ_{_{G}}_{,t}^{G}−rᵢ_{_{G}}_{,t}^{G,d})≤Rᵢ_{_{G}}^{G,u},∀i_{G}∈I^{G},∀t∈[1,T−1]

where Pᵢ_{_{G}}_{,t+1}^{G} is active power of the generator i_{G} at a dispatching time point t+1, rᵢ_{_{G}}_{,t+1}^{G,d} is an upward reserve capacity supplied by the generator i_{G} at the dispatching time point t+1, Rᵢ_{_{G}}^{G,d} is a downward ramp rate of the generator i_{G}, and Rᵢ_{_{G}}^{G,u} is an upward ramp rate of the generator i_{G};

(1-4) establishing a constraint on the reactive power of the generator:

Tᵢ_{_{G}}^{G,min}≤Qᵢ_{_{G}}_{,t}^{G}≤Qᵢ_{_{G}}^{G,max},∀i_{G}∈I^{G},t∈[1,T]

where Qᵢ_{_{G}}^{G,min} is a lower limit of the reactive power of the generator i_{G}, and Qᵢ_{_{G}}^{G,max} is an upper limit of the reactive power of the generator i_{G};

(1-5) establishing a constraint on power system load flow:

$${P}_{i , t}^{pf} = {\sum }_{j ∈ {I}^{B}} {U}_{i , t}^{pf} {U}_{j , t}^{pf} ( {G}_{ij}^{pf} cos {δ}_{ij , t}^{pf} + {B}_{ij}^{pf} sin {δ}_{ij , t}^{pf} ) , ∀ i ∈ {I}^{B} , t ∈ [ 1 , T ]$$

$${Q}_{i , t}^{pf} = {\sum }_{i ∈ {I}^{B}} {U}_{i , t}^{pf} {U}_{j , t}^{pf} ( {G}_{ij}^{pf} sin {δ}_{ij , t}^{pf} - {B}_{ij}^{pf} cos {δ}_{ij , t}^{pf} ) , ∀ i ∈ {I}^{B} , t ∈ [ 1 , T ]$$

$${δ}_{ij , t}^{pf} = {δ}_{i , t}^{pf} - {δ}_{j , t}^{pf} , ∀ i , j ∈ {I}^{B} , t ∈ [ 1 , T ]$$

$${( {I}_{ij , t}^{pf} )}^{2} = \frac{{( {P}_{i , t}^{pf} )}^{2} + {( {Q}_{i , t}^{pf} )}^{2}}{{( {U}_{i , t}^{pf} )}^{2}} , ∀ i , j ∈ {I}^{B} , t ∈ [ 1 , T ]$$

where I^{B} is a set of all the buses in the power system, U_{j,t}^{p f} is a voltage magnitude of the node j at the dispatching time t, Gᵢⱼ^{p f} is a real part of an element in line i and column j of a power network node admittance matrix Y, Bᵢⱼ^{p f} is an imaginary part of the element in line i and column j of the power network node admittance matrix Y, wherein the power network node admittance matrix Y is acquired from an energy management system of an electro-thermal coupling multi-energy flow system, and δ_{ij,t}^{p f} is a voltage phase angle difference between the node i and the node j at the dispatching time t;

(1-6) establishing a constraint on a line capacity:

(I_{ij,t}^{p f})²≤(Iᵢⱼ^{p f,max})²,∀i,j∈I^{B},t∈[1,T]

where Iᵢⱼ^{p f,max} is an upper limit of the current in the power line between the node i and the node j;

(1-7) establishing constraints on the voltage magnitude and voltage phase angle of the node:

Uᵢ^{p f,min}≤U_{i,t}^{p f}≤Uᵢ^{p f,max},i∈I^{B},t∈[1,T]

δᵢ^{p f,min}≤δ_{i,t}^{p f}≤δᵢ^{p f,max},i∈I^{B},t∈[1,T]

where Uᵢ^{p f,min} is a lower limit of the voltage magnitude of the node i, Uᵢ^{p f,max} is an upper limit of the voltage magnitude of the node i, δᵢ^{p f,min} is a lower limit of the voltage phase angle of the node i, and δᵢ^{p f,max} is an upper limit of the voltage phase angle of the node i;

(1-8) establishing constraints on the active power and the reactive power injected at the node:

$${P}_{i , t}^{pf} = - {P}_{i , t}^{L} + {P}_{i , t}^{lc} + {\sum }_{{i}_{G} ∈ {I}_{i}^{G}} {P}_{{i}_{G} , t}^{G} + {\sum }_{{i}_{W} ∈ {I}_{i}^{W}} {P}_{{i}_{W} , t}^{W} , ∀ i ∈ {I}^{B} , t ∈ [ 1 , T ]$$

$${Q}_{i , t}^{pf} = - {Q}_{i , t}^{L} + {Q}_{i , t}^{lc} + {\sum }_{{i}_{G} ∈ {I}_{i}^{G}} {Q}_{{i}_{G} , t}^{G} , ∀ i ∈ {I}^{B} , t ∈ [ 1 , T ]$$

where P_{i,t}^{lc} is active power of a removed load at the node i at the dispatching time point t, Iᵢ^{G} is a set constituted by all the generators connected at the node i, i_{W} is a serial number of a wind farm, Iᵢ^{W} is a set constituted by all the wind farms connected at the node i, Pᵢ_{_{W}}_{,t}^{W} is active power of the wind farm i_{W} at the dispatching time point t, and Q_{i,t}^{lc} is reactive power of the removed load at the node i at the dispatching time point t;

(1-9) establishing a constraint on the active power of the removed load:

0≤P_{i,t}^{lc}≤P_{i,t}^{L},∀i∈I^{B},t∈[1,T]

(1-10) establishing constraints on active power, reactive power and a voltage magnitude of a load:

$${P}_{i , t}^{L} = {P}_{i , t}^{B} ( {{a}_{i , t}^{p} ( \frac{{U}_{i , t}^{pf}}{{U}_{N}^{pf}} )}^{2} + {b}_{i , t}^{p} \frac{{U}_{i , t}^{pf}}{{U}_{N}^{pf}} + {c}_{i , t}^{p} ) , i ∈ {I}^{B} , t ∈ [ 1 , T ]$$

$${Q}_{i , t}^{L} = {Q}_{i , t}^{B} ( {{a}_{i , t}^{q} ( \frac{{U}_{i , t}^{pf}}{{U}_{N}^{pf}} )}^{2} + {b}_{i , t}^{q} \frac{{U}_{i , t}^{pf}}{{U}_{N}^{pf}} + {c}_{i , t}^{q} ) + {{Q}_{i , t}^{FC} ( \frac{{U}_{i , t}^{pf}}{{U}_{N}^{pf}} )}^{2} , i ∈ {I}^{B} , t ∈ [ 1 , T ]$$

where P_{i,t}^{B} is active power of the node i under a rated voltage at the dispatching time point t, U_{N}^{p f} is the rated voltage, a_{i,t}^{p}. b_{i,t}^{p} and c_{i,t}^{p} are a second-order coefficient, a first-order coefficient and a constant term of a node injected active power model, respectively, Q_{i,t}^{B} is reactive power of the node i under the rated voltage at the dispatching time point t, Q_{i,t}^{FC} is a capacity of a reactive power compensation device input at the node i at the dispatching time point t, and a_{i,t}^{q}, b_{i,t}^{q} and c_{i,t}^{q} are a second-order coefficient, a first-order coefficient and a constant term of a node injected reactive power model, respectively;

(1-11) establishing a range constraint on the voltage stability index:

$${L}_{i , t} = \vert 1 - \frac{{\sum }_{j ∈ {𝒥}^{G}} {F}_{ij} {U}_{j}^{pf}}{{U}_{i}^{pf}} \vert , i ∈ {I}^{B} , t ∈ [ 1 , T ]$$

$${L}_{i , t} \leq {L}^{max} , i ∈ {I}^{B} , t ∈ [ 1 , T ]$$

where ϑ^{G} represents a set of nodes connected to a generator, Fᵢⱼ is a submatrix of a hybrid parameter matrix, and L^{max} is an upper limit of the voltage stability index;

(1-12) establishing constraints on the active power and abandoned active power of the wind farm:

0≤Pᵢ_{_{W}}_{,t}^{W}≤Pᵢ_{_{W}}_{,t}^{W,F},∀i_{W}∈I^{W},t∈[1,T]

Pᵢ_{_{W}}_{,t}^{wd}=Pᵢ_{_{W}}_{,t}^{W,F}−Pᵢ_{_{W}}_{,t}^{W},∀i_{W}∈I^{W},t∈[1,T]

where Pᵢ_{_{W}}_{,t}^{W,F} is a predicted value of the active power of the wind farm i_{W} at the dispatching time point t, Pᵢ_{_{W}}_{,t}^{wd} is the abandoned active power of the wind farm i_{W} at the dispatching time point t, and I^{W} is a set constituted by all the wind farms;

(1-13) establishing constraints on a total upward reserve capacity and a total downward reserve capacity of the power system:

$${\sum }_{i ∈ {I}^{B}} {r}_{i , t}^{B , u} + {\sum }_{{i}_{G} ∈ {I}^{G}} {r}_{{i}_{G} , t}^{G , u} \geq {r}_{t}^{sys , u} , t ∈ [ 1 , T ]$$

$${\sum }_{i ∈ {I}^{B}} {r}_{i , t}^{B , d} + {\sum }_{{i}_{G} ∈ {I}^{G}} {r}_{{i}_{G} , t}^{G , d} \geq {r}_{t}^{sys , d} , t ∈ [ 1 , T ]$$

where r_{i,t}^{B,u} is an upward reserve capacity provided by a voltage sensitive load at the node i at the dispatching time point t, r_{i,t}^{B,d} is a downward reserve capacity provided by a voltage sensitive load at the node i at the dispatching time point t, rₜ^{sys,u} is a total upward reserve capacity needed by the power system at the dispatching time point t, and rₜ^{sys,d} is a total downward reserve capacity needed by the power system at the dispatching time point t;

(1-14) establishing a constraint on a reserve capacity of the voltage sensitive load:

$${r}_{i , t}^{B , u} \leq Δ {P}_{i , t}^{{L}^{′}} = {P}_{i , t}^{B} ( 2 {a}_{i , t}^{p} \frac{Δ {U}_{i , t}^{{pf}^{′}}}{{U}_{N}^{pf}} + {b}_{i , t}^{p} ) , i ∈ {I}^{B} , t ∈ [ 1 , T ]$$

$${r}_{i , t}^{B , d} \leq Δ {P}_{i , t}^{{L}^{″}} = {P}_{i , t}^{B} ( 2 {a}_{i , t}^{p} \frac{Δ {U}_{i , t}^{{pf}^{″}}}{{U}_{N}^{pf}} + {b}_{i , t}^{p} ) , i ∈ {I}^{B} , t ∈ [ 1 , T ]$$

where ΔP_{i,t}^{L′} is a variation of the active power of the load at the node z at the dispatching time point t when the voltage sensitive load provides the upward reserve capacity, U_{i,t}^{p f′} is a variation of the voltage magnitude of the node i at the dispatching time point t when the voltage sensitive load provides the upward reserve capacity, ΔP_{i,t}^{L″} is a variation of the active power of the load at the node i at the dispatching time point t when the voltage sensitive load provides the downward reserve capacity, and ΔU_{i,t}^{p f″} is a variation of the voltage magnitude of the node i at the dispatching time point t when the voltage sensitive load provides the downward reserve capacity;

(2) establishing an evaluation model of a voltage sensitive load regulation range:

(2-1) establishing a first variable regulation model in the power system when the voltage sensitive load provides the upward reserve capacity:

(2-1-1) establishing a set Ω^{Δ′} of regulated variables in the power system when the voltage sensitive load provides the upward reserve capacity:

Ω^{Δ′}={ΔPᵢ_{_{G}}_{,t}^{G′},ΔQᵢ_{_{G}}_{,t}^{G′},ΔP_{i,t}^{p f′},ΔQ_{i,t}^{p f′},ΔU_{i,t}^{p f′},Δδ_{i,t}^{p f′},ΔI_{ij,t}^{p f′},ΔL_{i,t}′}

where ΔPᵢ_{_{G}}_{,t}^{G′} is a variation of the active power of the generator i, at the dispatching time point t when the voltage sensitive load provides the upward reserve capacity, ΔQᵢ_{_{G}}_{,t}^{G′} is a variation of the reactive power of the generator i_{G} at the dispatching time point t when the voltage sensitive load provides the upward reserve capacity, ΔP_{i,t}^{p f′} is a variation of the active power injected at the node i at the dispatching time point t when the voltage sensitive load provides the upward reserve capacity, ΔQ_{i,t}^{p f′} is a variation of the reactive power injected at the node i at the dispatching time point t when the voltage sensitive load provides the upward reserve capacity, ΔU_{i,t}^{p f′} is a variation of the voltage magnitude of the node i at the dispatching time point t when the voltage sensitive load provides the upward reserve capacity, Δδ_{i,t}^{p f′} is a variation of the voltage phase angle of the node i at the dispatching time point t when the voltage sensitive load provides the upward reserve capacity, ΔI_{ij,t}^{p f′} is a variation of the current in the power line between the node i and the node j at the dispatching time point t when the voltage sensitive load provides the upward reserve capacity, and ΔL_{i,t}′ is a variation of the voltage stability index of the node i when the voltage sensitive load provides the upward reserve capacity;

(2-1-2) establishing a constraint among the variations of the active power, the reactive power, the voltage magnitudes and the voltage phase angles injected at respective nodes:

$$[ \begin{matrix}Δ {P}_{t}^{{pf}^{′}} \\ Δ {Q}_{t}^{{pf}^{′}}\end{matrix} ] = {J}^{pf} [ \begin{matrix}{Δδ}_{t}^{{pf}^{′}} \\ Δ {U}_{t}^{{pf}^{′}} \text{/} {U}_{t}^{pf}\end{matrix} ]$$

where ΔPₜ^{p f′} is a column vector constituted by the variations ΔP_{i,t}^{p f′} of the active power injected at respective nodes i at the dispatching time point t when the voltage sensitive load provides the upward reserve capacity, ΔQₜ^{p f′} is a column vector constituted by the variations ΔQ_{i,t}^{p f′} of the reactive power injected at respective nodes i at the dispatching time point t when the voltage sensitive load provides the upward reserve capacity, Δδₜ^{p f′} is a column vector constituted by the variations Δδ_{i,t}^{p f′} the voltage phase angles of the respective nodes i at the dispatching time point t when the voltage sensitive load provides the upward reserve capacity, ΔUₜ^{p f′} is a column vector constituted by the variations ΔU_{i,t}^{p f′} of the voltage magnitude of the respective nodes i at the dispatching time point t when the voltage sensitive load provides the upward reserve capacity, J^{p f} is a Jacobian matrix of power flow equation, which is obtained from the energy management system of the electro-thermal coupling multi-energy flow system;

(2-1-3) establishing constraints on the variations of the active power and the reactive power injected at respective nodes:

$$Δ {P}_{i , t}^{{pf}^{′}} = - Δ {P}_{i , t}^{{L}^{′}} + ΣΔ {P}_{{i}_{G} , t}^{{G}^{′}} , i ∈ {I}^{B} , t ∈ [ 1 , T ]$$

$$Δ {Q}_{i , t}^{{pf}^{′}} = - Δ {Q}_{i , t}^{{L}^{′}} + ΣΔ {Q}_{{i}_{G} , t}^{{G}^{′}} , i ∈ {I}^{B} , t ∈ [ 1 , T ] \\ - {R}_{{i}_{G}}^{G , d} \leq Δ {P}_{{i}_{H} , t}^{{G}^{′}} \leq {R}_{{i}_{G}}^{G , u} , {i}_{G} ∈ {I}^{G} , t ∈ [ 1 , T ]$$

where ΔP_{i,t}^{L′} is a variation of the active power of the load at the node i at the dispatching time point t when the voltage sensitive load provides the upward reserve capacity, and ΔQ_{i,t}^{L′} is a variation of the reactive power of the load at the node i at the dispatching time point t when the voltage sensitive load provides the upward reserve capacity;

(2-1-4) establishing a constraint equation of the variation of the current in the power line:

$${( {I}_{ij , t}^{pf} )}^{2} + Δ {I}_{ij , t}^{{pf}^{′}} \leq {( {I}_{ij}^{pf , max} )}^{2} , i ∈ {I}^{B} , j ∈ {I}^{B} , t ∈ [ 1 , T ]$$

$$Δ {I}_{ij , t}^{{pf}^{′}} = 2 {I}_{ij , t}^{pf} [ \frac{\partial {I}_{ij , t}^{pf}}{≢ {U}^{pf}} \frac{\partial {I}_{ij , t}^{pf}}{\partial {δ}^{pf}} ] [ \begin{matrix}Δ {U}_{t}^{{pf}^{′}} \\ {Δδ}_{t}^{{pf}^{′}}\end{matrix} ] , i ∈ {I}^{B} , j ∈ {I}^{B} , t ∈ [ 1 , T ]$$

where U^{p f} is a voltage magnitude,

$$\frac{\partial {I}_{ij , t}^{pf}}{\partial {U}^{pf}}$$

is a sensitivity of I_{ij,t}^{p f} to the voltage magnitude, and is obtained from the energy management system of the electro-thermal coupling multi-energy flow system, δ^{p f} is a voltage phase angle, and

$$\frac{\partial {I}_{ij , t}^{pf}}{\partial {δ}^{pf}}$$

is a sensitivity of I_{ij,t}^{p f} to the voltage magnitude, angle, and is obtained from the energy management system of the electro-thermal coupling multi-energy flow system;

(2-1-5) establishing constraints on the voltage magnitude and the voltage phase angle:

Uᵢ^{p f,min}≤U_{i,t}^{p f}+ΔU_{i,t}^{p f′}≤Uᵢ^{p f,max},i∈I^{B},t∈[1,T]

δᵢ^{p f,min}≤δ_{i,t}^{p f}+Δδ_{i,t}^{p f′}≤δᵢ^{p f,max},i∈I^{B},t∈[1,T]

(2-1-6) establishing constraints on the active power and the reactive power of the generator:

Pᵢ_{_{G}}^{G,min}≤Pᵢ_{_{G}}_{,t}^{G}+ΔPᵢ_{_{G}}_{,t}^{G′}≤Pᵢ_{_{G}}^{G,max},i_{G}∈I^{G},t∈[1,T]

Qᵢ_{_{G}}^{G,min}≤Qᵢ_{_{G}}_{,t}^{G}+ΔQᵢ_{_{G}}_{,t}^{G′}≤Qᵢ_{_{G}}^{G,max},i_{G}∈I^{G},t∈[1,T]

(2-1-7) establishing constraints on the variations of the active power and the reactive power of the load:

$$Δ {P}_{i , t}^{{L}^{′}} = {P}_{i , t}^{B} ( 2 {a}_{i , t}^{p} \frac{Δ {U}_{i , t}^{{pf}^{′}}}{{U}_{N}^{pf}} + {b}_{i , t}^{p} ) , i ∈ {I}^{B} , t ∈ [ 1 , T ]$$

$$Δ {Q}_{i , t}^{{L}^{′}} = {Q}_{i , t}^{B} ( 2 {a}_{i , t}^{q} \frac{Δ {U}_{i , t}^{{pf}^{′}}}{{U}_{N}^{pf}} + {b}_{i , t}^{q} + 2 {Q}_{i , t}^{FC} \frac{Δ {U}_{i , t}^{{pf}^{′}}}{{U}_{N}^{pf}} ) , i ∈ {I}^{B} , t ∈ [ 1 , T ]$$

(2-1-8) establishing a voltage stability index constraint equation:

$${L}_{i , t} + Δ {L}_{i , t}^{′} \leq {L}^{max}$$

$$Δ {L}_{i , t}^{′} = [ \frac{\partial L}{\partial {U}_{t}^{pf}} \frac{\partial L}{\partial {δ}_{t}^{pf}} ] [ \begin{matrix}Δ {U}_{t}^{{pf}^{′}} \\ {Δδ}_{t}^{{pf}^{′}}\end{matrix} ]$$

where

$$\frac{\partial L}{\partial {U}_{t}^{pf}}$$

is a sensitivity of the voltage stability index to the voltage magnitude, and is obtained from the energy management system of the electro-thermal coupling multi-energy flow system;

$$\frac{\partial L}{\partial {δ}_{t}^{pf}}$$

is a sensitivity of the voltage stability index to the voltage phase angle, and is obtained from the energy management system of the electro-thermal coupling multi-energy flow system;

(2-2) establishing a second variable regulation model in the power system when the voltage sensitive load provides the downward reserve capacity:

(2-2-1) establishing a set Ω^{Δ″} of regulated variables in the power system when the voltage sensitive load provides the downward reserve capacity:

Ω^{Δ″}={ΔPᵢ_{_{G}}_{,t}^{G″},ΔGᵢ_{_{G}}_{,t}^{G″},ΔP_{i,t}^{p f″},ΔQ_{i,t}^{p f″},ΔU_{i,t}^{p f″},Δδ_{i,t}^{p f″},ΔI_{ij,t}^{p f″},ΔL_{i,t}″}

where ΔPᵢ_{_{G}}_{,t}^{G″} is a variation of the active power of the generator i_{G} at the dispatching time point t when the voltage sensitive load provides the downward reserve capacity, ΔQᵢ_{_{G}}_{,t}^{G″} is a variation of the reactive power of the generator i_{G} at the dispatching time point t when the voltage sensitive load provides the downward reserve capacity, ΔP_{i,t}^{p f″} is a variation of the active power injected at the node i at the dispatching time point t when the voltage sensitive load provides the downward reserve capacity, ΔQ_{i,t}^{p f″} is a variation of the reactive power injected at the node i at the dispatching time point t when the voltage sensitive load provides the downward reserve capacity, ΔU_{i,t}^{p f″} is a variation of the voltage magnitude of the node i at the dispatching time point t when the voltage sensitive load provides the downward reserve capacity, Δδ_{i,t}^{p f″} is a variation of the voltage phase angle of the node i at the dispatching time point t when the voltage sensitive load provides the downward reserve capacity, ΔI_{ij,t}^{p f″} is a variation of the current in the power line between the node i and the node j at the dispatching time point t when the voltage sensitive load provides the downward reserve capacity, and ΔL_{i,t}″ is a variation of the voltage stability index of the node i when the voltage sensitive load provides the downward reserve capacity;

(2-2-2) establishing a constraint among the variations of the active power, the reactive power, the voltage magnitudes and the voltage phase angles injected at respective nodes:

$$[ \begin{matrix}Δ {P}_{t}^{{pf}^{″}} \\ Δ {Q}_{t}^{{pf}^{″}}\end{matrix} ] = {J}^{pf} [ \begin{matrix}{Δδ}_{t}^{{pf}^{″}} \\ Δ {U}_{t}^{{pf}^{″}} \text{/} {U}_{t}^{pf}\end{matrix} ]$$

where ΔPₜ^{p f″} is a column vector constituted by the variations ΔP_{i,t}^{p f″} of the active power injected at respective nodes i at the dispatching time point t when the voltage sensitive load provides the downward reserve capacity, ΔQₜ^{p f″} is a column vector constituted by the variations ΔQ_{i,t}^{p f″} of the reactive power injected at respective nodes i at the dispatching time point t when the voltage sensitive load provides the downward reserve capacity, Δδₜ^{p f″} is a column vector constituted by the variations Δδ_{i,t}^{p f″} of the voltage phase angles of the respective nodes i at the dispatching time point t when the voltage sensitive load provides the downward reserve capacity, and ΔUₜ^{p f″} is a column vector constituted by the variations ΔU_{i,t}^{p f″} of the voltage magnitude of the respective nodes i at the dispatching time point t when the voltage sensitive load provides the downward reserve capacity;

(2-2-3) establishing constraints on the variations of the active power and the reactive power injected at respective nodes:

$$Δ {P}_{i , t}^{{pf}^{″}} = - Δ {P}_{i , t}^{{L}^{″}} + ΣΔ {P}_{{i}_{G} , t}^{{G}^{″}} , i ∈ {I}^{B} , t ∈ [ 1 , T ]$$

$$Δ {Q}_{i , t}^{{pf}^{″}} = - Δ {Q}_{i , t}^{{L}^{″}} + ΣΔ {Q}_{{i}_{G} , t}^{{G}^{″}} , i ∈ {I}^{B} , t ∈ [ 1 , T ] \\ - {R}_{{i}_{G}}^{G , d} \leq Δ {P}_{{i}_{G} , t}^{{G}^{″}} \leq {R}_{{i}_{G}}^{G , u} , {i}_{G} ∈ {I}^{G} , t ∈ [ 1 , T ]$$

where ΔP_{i,t}^{L″} is a variation of the active power of the load at the node i at the dispatching time point t when the voltage sensitive load provides the downward reserve capacity, and ΔQ_{i,t}^{L″} is a variation of the reactive power of the load at the node i at the dispatching time point t when the voltage sensitive load provides the downward reserve capacity;

(2-2-4) establishing a constraint on the variation of the current in the power line:

$${( {I}_{ij , t}^{pf} )}^{2} + Δ {I}_{ij , t}^{{pf}^{″}} \leq {( {I}_{ij}^{pf , max} )}^{2} , i ∈ {I}^{B} , j ∈ {I}^{B} , t ∈ [ 1 , T ]$$

$$Δ {I}_{ij , t}^{{pf}^{″}} = 2 {I}_{ij , t}^{pf} [ \frac{\partial {I}_{ij , t}^{pf}}{\partial {U}^{pf}} \frac{\partial {I}_{ij , t}^{pf}}{\partial {δ}^{pf}} ] [ \begin{matrix}Δ {U}_{t}^{{pf}^{″}} \\ {Δδ}_{t}^{{pf}^{″}}\end{matrix} ] , i ∈ {I}^{B} , j ∈ {I}^{B} , t ∈ [ 1 , T ]$$

(2-2-5) establishing constraints on the voltage magnitude and the voltage phase angle:

Uᵢ^{p f,min}≤U_{i,t}^{p f}+ΔU_{i,t}^{p f″}≤Uᵢ^{p f,max},i∈I^{B},t∈[1,T]

δᵢ^{p f,min}≤δ_{i,t}^{p f}+Δδ_{i,t}^{p f″}≤δᵢ^{p f,max},i∈I^{B},t∈[1,T]

(2-2-6) establishing constraints on the active power and the reactive power of the generator:

Pᵢ_{_{G}}^{G,min}≤Pᵢ_{_{G}}_{,t}^{G}+ΔPᵢ_{_{G}}_{,t}^{G″}≤Pᵢ_{_{G}}^{G,max},i_{G}∈I^{G},t∈[1,T]

Qᵢ_{_{G}}^{G,min}≤Qᵢ_{_{G}}_{,t}^{G}+ΔQᵢ_{_{G}}_{,t}^{G″}≤Qᵢ_{_{G}}^{G,max},i_{G}∈I^{G},t∈[1,T]

(2-2-7) establishing constraints on the variations of the active power and the reactive power of the load:

$$Δ {P}_{i , t}^{{L}^{″}} = {P}_{i , t}^{B} ( 2 {a}_{i , t}^{p} \frac{Δ {U}_{i , t}^{{pf}^{″}}}{{U}_{N}^{pf}} + {b}_{i , t}^{p} ) , i ∈ {I}^{B} , t ∈ [ 1 , T ]$$

$$Δ {Q}_{i , t}^{{L}^{″}} = {Q}_{i , t}^{B} ( 2 {a}_{i , t}^{q} \frac{Δ {U}_{i , t}^{{pf}^{″}}}{{U}_{N}^{pf}} + {b}_{i , t}^{q} + 2 {Q}_{i , t}^{FC} \frac{Δ {U}_{i , t}^{{pf}^{″}}}{{U}_{N}^{pf}} ) , i ∈ {I}^{B} , t ∈ [ 1 , T ]$$

(2-2-8) establishing a voltage stability index constraint equation:

$${L}_{i , t} + Δ {L}_{i , t}^{″} \leq {L}^{max}$$

$$Δ {L}_{i , t}^{″} = [ \frac{\partial L}{\partial {U}_{t}^{pf}} \frac{\partial L}{{Δδ}_{t}^{pf}} ] [ \begin{matrix}Δ {U}_{t}^{{pf}^{″}} \\ {Δδ}_{t}^{{pf}^{″}}\end{matrix} ]$$

(3) establishing an optimization objective of power system dispatch:

min F^{G}(Pₜ^{G},rₜ^{G,u},rₜ^{G,d})+F^{P}(Pₜ^{wd},Pₜ^{lc})−F^{B}(Pₜ^{L})

where Pₜ^{G} is a column vector constituted by the active power Pᵢ_{_{G}}_{,t}^{G} of all the generators in the power system, rₜ^{G,u} is a column vector constituted by the upward reserve capacities rᵢ_{_{G}}_{,t}^{G,u} provided by all the generators in the power system, rₜ^{G,d} is a column vector constituted by the downward reserve capacities rᵢ_{_{G}}_{,t}^{G,d} provided by all the generators in the power system, F^{G}(Pₜ^{G},rₜ^{G,u},rₜ^{G,d}) is the cost of providing the active power and reserve capacities by all the generators in the power system, Pₜ^{wd} is a column vector constituted by the active power Pᵢ_{_{W}}_{,t}^{wd} abandoned by all the wind farms in the power system, Pₜ^{lc} is a column vector constituted by the active power P_{i,t}^{lc} of all the removed loads in the power system, F^{P}(Pₜ^{wd},Pₜ^{lc}) is the cost of abandoned wind farms and the removed loads in the power system, Pₜ^{L} is a column vector constituted by the active power P r of all the electrical loads in the power system, and F^{B} (Pₜ^{L}) is sales revenue of the power system; and

(4) constructing an optimized power system dispatching model considering the voltage sensitive load reserve by the ground state operating point model of the power system established in step (1), the evaluation model of the voltage sensitive load regulation range established in step (2) and the optimization objective of power system dispatch established in step (3), solving the optimized power system dispatching model by an interior point method to obtain dispatching parameters of the power system, including the active power Pᵢ_{_{G}}_{,t}^{G} of the generator i_{G}, the reactive power Qᵢ_{_{G}}_{,t}^{G} of the generator i_{G}, the active power P_{i,t}^{L} of the load at the node i, and the reactive power Q_{i,t}^{L} of the load at the node i, to complete power system dispatching considering voltage sensitive load reserve.

The power system dispatching method considering voltage sensitive load reserve proposed by the present disclosure has the following advantages:

In the power system dispatching method considering voltage sensitive load reserve according to embodiments of the present disclosure, a power system dispatching model constituted by a ground state operating point model of the power system, the evaluation model of the voltage sensitive load regulation range and the optimization objective of power system dispatch is established, by solving the power system dispatching model, a power system dispatching solution considering voltage sensitive load reserve is obtained. This method can make full use of the regulation ability of voltage sensitive load to supplement the reserve capacity of the power system and help the power system to control the active power. Further, the method of the present disclosure can maximize the sales revenue of the power system on the premise of meeting the voltage stability index constraint, and ensure the safe and economic operation of the power system.

In a second aspect of embodiments of the present disclosure, a power system dispatching device considering voltage sensitive load reserve is provided. The device includes a processor, and a memory having stored therein a computer program that, when executed by the processor, causes the processor to perform the method as described in the first aspect of embodiments of the present disclosure.

In a third aspect of embodiments of the present disclosure, a non-transitory computer-readable storage medium having stored therein instructions that, when executed by a processor, causes the processor to perform the method as described in the first aspect of embodiments of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

In embodiments of the present disclosure, there is provided a power system dispatching method considering voltage sensitive load reserve, which includes:

(1) establishing a ground state operating point model of a power system:

(1-1) establishing a variable set Ω of the ground state operating point model of the power system:

Ω={Pᵢ_{_{G}}_{,t}^{G},rᵢ_{_{G}}_{,t}^{G,u},rᵢ_{_{G}}_{,t}^{G,d},Qᵢ_{_{G}}_{,t}^{G},P_{i,t}^{p f},Q_{i,t}^{p f},U_{i,t}^{p f},δ_{i,t}^{p f},I_{ij,t}^{p f},P_{i,t}^{L},Q_{i,t}^{L},L_{i,t}},

where i_{G} is a serial number of a generator, t is a dispatching time point, Pᵢ_{_{G}}_{,t}^{G} is active power of the generator i_{G} at the dispatching time point t, rᵢ_{_{G}}_{,t}^{G,u} is an upward reserve capacity supplied by the generator i_{G} at the dispatching time point t, rᵢ_{_{G}}_{,t}^{G,d} is a downward reserve capacity supplied by the generator i_{G} at the dispatching time point t, Qᵢ^{G}ₜ is reactive power of the generator i_{G} at the dispatching time point t, i is a serial number of a node, P_{i,t}^{p f} is active power injected at the node i at the dispatching time point t, Q_{i,t}^{p f} is reactive power injected at the node i at the dispatching time point t, U_{i,t}^{p f} is a voltage magnitude of the node i at the dispatching time point t, δ_{i,t}^{p f} is a voltage phase angle of the node i at the dispatching time point t, j is a serial number of a node connected to the node i, I_{ij,t}^{p f} is a current in a power line between the node i and the node j at the dispatching time point t, P_{i,t}^{L} is active power of a load at the node i at the dispatching time point t, Q_{i,t}^{L} is reactive power of the load at the node i at the dispatching time point t, and L_{i,t} is a voltage stability index of the node i at the dispatching time point t;

(1-2) establishing a constraint on the active power of the generator:

Pᵢ_{_{G}}^{G,min}≤Pᵢ_{_{G}}_{,t}^{G}≤Pᵢ_{_{G}}^{G,max},∀i_{G}∈I^{G},t∈[1,T]

where Pᵢ_{_{G}}^{G,min} is a lower limit of the active power of the generator i_{G}, Pᵢ_{_{G}}^{G,max} is an upper limit of the active power of the generator i_{G}, I^{G} is a set constituted by all the generators, and T is the total number of dispatching time points;

(1-3) establishing constraints on a reserve capacity and a ramp rate of the generator:

0≤rᵢ_{_{G}}_{,t}^{G,u}≤Pᵢ_{_{G}}^{G,max}−Pᵢ_{_{G}}_{,t}^{G},∀i_{G}∈I^{G},t∈[1,T]

0≤rᵢ_{_{G}}_{,t}^{G,d}≤Pᵢ_{_{G}}_{,t}^{G}−Pᵢ_{_{G}}^{G,min},∀i_{G}∈I^{G},t∈[1,T]

(Pᵢ_{_{G}}_{,t}^{G}+rᵢ_{_{G}}_{,t}^{G,u})−(Pᵢ_{_{G}}_{,t+1}^{G}−rᵢ_{_{G}}_{,t+1}^{G,d})≤Rᵢ_{_{G}}^{G,d},∀i_{G}∈I^{G},∀t∈[1,T−1]

(Pᵢ_{_{G}}_{,t+1}^{G}+rᵢ_{_{G}}_{,t+1}^{G,u})−(Pᵢ_{_{G}}_{,t}^{G}−rᵢ_{_{G}}_{,t}^{G,d})≤Rᵢ_{_{G}}^{G,u},∀i_{G}∈I^{G},∀t∈[1,T−1]

where Pᵢ_{_{G}}_{,t+1}^{G} is active power of the generator i_{G} at a dispatching time point t+1, rᵢ_{_{G}}_{,t+1}^{G,d} is an upward reserve capacity supplied by the generator i_{G} at the dispatching time point t+1, Rᵢ_{_{G}}^{G,d a downward ramp rate of the generator i}_{G}, and Rᵢ_{_{G}}^{G,u} is an upward ramp rate of the generator i_{G};

(1-4) establishing a constraint on the reactive power of the generator:

Qᵢ_{_{G}}^{G,min}≤Qᵢ_{_{G}}_{,t}^{G}≤Qᵢ_{_{G}}^{G,max},∀i_{G}∈I^{G},t∈[1,max]

where Qᵢ_{_{G}}^{G,min} is a lower limit of the reactive power of the generator i_{G}, and Qᵢ_{_{G}}^{G,max} is an upper limit of the reactive power of the generator i_{G};

(1-5) establishing a constraint on power system load flow:

$${P}_{i , t}^{pf} = {\sum }_{i ∈ {I}^{B}} {U}_{i , t}^{pf} {U}_{j , t}^{pf} ( {G}_{ij}^{pf} cos {δ}_{ij , t}^{pf} + {B}_{ij}^{pf} sin {δ}_{ij , t}^{pf} ) , ∀ i ∈ {I}^{B} , t ∈ [ 1 , T ]$$

$${Q}_{i , t}^{pf} = {\sum }_{i ∈ {I}^{B}} {U}_{i , t}^{pf} {U}_{j , t}^{pf} ( {G}_{ij}^{pf} sin {δ}_{ij , t}^{pf} - {B}_{ij}^{pf} cos {δ}_{ij , t}^{pf} ) , ∀ i ∈ {I}^{B} , t ∈ [ 1 , T ]$$

$${δ}_{ij , t}^{pf} = {δ}_{i , t}^{pf} - {δ}_{j , t}^{pf} , ∀ i , j ∈ {I}^{B} , t ∈ [ 1 , T ]$$

$${( {I}_{ij , t}^{pf} )}^{2} = \frac{{( {P}_{i , t}^{pf} )}^{2} + {( {Q}_{i , t}^{pf} )}^{2}}{{( {U}_{i , t}^{pf} )}^{2}} , ∀ i , j ∈ {I}^{B} , t ∈ [ 1 , T ]$$

where I^{B} is a set of all the buses in the power system, U_{j,t}^{p f} is a voltage magnitude of the node j at the dispatching time t, Gᵢⱼ^{p f} is a real part of an element in line i and column j of a power network node admittance matrix Y, Bᵢⱼ^{p f} is an imaginary part of the element in line i and column j of the power network node admittance matrix Y, wherein the power network node admittance matrix Y is acquired from an energy management system of an electro-thermal coupling multi-energy flow system, and δ_{ij,t}^{p f} is a voltage phase angle difference between the node i and the node j at the dispatching time t;

(1-6) establishing a constraint on a line capacity:

(I_{ij,t}^{p f})²≤(Iᵢⱼ^{p f,max})²,∀i,j∈I^{B},t∈[1,T]

where Iᵢⱼ^{p f,max} is an upper limit of the current in the power line between the node i and the node j;

(1-7) establishing constraints on the voltage magnitude and voltage phase angle of the node:

Uᵢ^{p f,min}≤U_{i,t}^{p f}≤Uᵢ^{p f,max},i∈I^{B},t∈[1,T]

δᵢ^{p f,min}≤δ_{i,t}^{p f}≤δᵢ^{p f,max},i∈I^{B},t∈[1,T]

where Uᵢ^{p f,min} is a lower limit of the voltage magnitude of the node i, Uᵢ^{p f,max} is an upper limit of the voltage magnitude of the node i, δᵢ^{p f,min} is a lower limit of the voltage phase angle of the node i, and δᵢ^{p f,max} is an upper limit of the voltage phase angle of the node i;

(1-8) establishing constraints on the active power and the reactive power injected at the node:

$${P}_{i , t}^{pf} = - {P}_{i , t}^{L} + {P}_{i , t}^{lc} + {\sum }_{{i}_{G} ∈ {I}_{i}^{G}} {P}_{{i}_{G} , t}^{G} + {\sum }_{{i}_{W} ∈ {I}_{i}^{W}} {P}_{{i}_{W} , t}^{W} , ∀ i ∈ {I}^{B} , t ∈ [ 1 , T ]$$

$${Q}_{i , t}^{pf} = - {Q}_{i , t}^{L} + {Q}_{i , t}^{lc} + {\sum }_{{i}_{G} ∈ {I}_{i}^{G}} {Q}_{{i}_{G} , t}^{G} , ∀ i ∈ {I}^{B} , t ∈ [ 1 , T ]$$

where P_{i,t}^{lc} is active power of a removed load at the node i at the dispatching time point t, Iᵢ^{G} is a set constituted by all the generators connected at the node i, i_{W} is a serial number of a wind farm, Iᵢ^{W} is a set constituted by all the wind farms connected at the node i, Pᵢ_{_{W}}_{,t}^{W} is active power of the wind farm i_{W} at the dispatching time point t, and Q_{i,t}^{lc} is reactive power of the removed load at the node i at the dispatching time point t;

(1-9) establishing a constraint on the active power of the removed load:

0≤P_{i,t}^{lc}≤P_{i,t}^{L},∀i∈I^{B},t∈[1,T]

(1-10) establishing constraints on active power, reactive power and a voltage magnitude of a load:

$${P}_{i , t}^{L} = {P}_{i , t}^{B} ( {{a}_{i , t}^{p} ( \frac{{U}_{i , t}^{pf}}{{U}_{N}^{pf}} )}^{2} + {b}_{i , t}^{p} \frac{{U}_{i , t}^{pf}}{{U}_{N}^{pf}} + {c}_{i , t}^{p} ) , i ∈ {I}^{B} , t ∈ [ 1 , T ]$$

$${Q}_{i , t}^{L} = {Q}_{i , t}^{B} ( {{a}_{i , t}^{q} ( \frac{{U}_{i , t}^{pf}}{{U}_{N}^{pf}} )}^{2} + {b}_{i , t}^{q} \frac{{U}_{i , t}^{pf}}{{U}_{N}^{pf}} + {c}_{i , t}^{q} ) + {{Q}_{i , t}^{FC} ( \frac{{U}_{i , t}^{pf}}{{U}_{N}^{pf}} )}^{2} , i ∈ {I}^{B} , t ∈ [ 1 , T ]$$

where P_{i,t}^{B} is active power of the node i under a rated voltage at the dispatching time point t, U_{N}^{p f} is the rated voltage, a_{i,t}^{p}. b_{i,t}^{p} and c_{i,t}^{p} are a second-order coefficient, a first-order coefficient and a constant term of a node injected active power model, respectively, Q_{i,t}^{B} is reactive power of the node i under the rated voltage at the dispatching time point t, Q_{i,t}^{FC} is a capacity of a reactive power compensation device input at the node i at the dispatching time point t, and a_{i,t}^{q}, b_{i,t}^{q} and c_{i,t}^{q} are a second-order coefficient, a first-order coefficient and a constant term of a node injected reactive power model, respectively;

(1-11) establishing a range constraint on the voltage stability index:

$${L}_{i , t} = \vert 1 - \frac{{\sum }_{j ∈ {𝒥}^{G}} {F}_{ij} {U}_{j}^{pf}}{{U}_{i}^{pf}} \vert , i ∈ {I}^{B} , t ∈ [ 1 , T ]$$

$${L}_{i , t} \leq {L}^{max} , i ∈ {I}^{B} , t ∈ [ 1 , T ]$$

where ϑ^{G} represents a set of nodes connected to a generator, Fᵢⱼ is a submatrix of a hybrid parameter matrix, and L^{max} is an upper limit of the voltage stability index;

(1-12) establishing constraints on the active power and abandoned active power of the wind farm:

0≤Pᵢ_{_{W}}_{,t}^{W}≤Pᵢ_{_{W}}_{,t}^{W,F},∀i_{W}∈I^{W},t∈[1,T]

Pᵢ_{_{W}}_{,t}^{wd}=Pᵢ_{_{W}}_{,t}^{W,F}−Pᵢ_{_{W}}_{,t}^{W},∀i_{W}∈I^{W},t∈[1,T]

where Pᵢ_{_{W}}_{,t}^{W,F} is a predicted value of the active power of the wind farm i_{W} at the dispatching time point t, Pᵢ_{_{W}}_{,t}^{wd} is the abandoned active power of the wind farm i_{W} at the dispatching time point t, and I^{W} is a set constituted by all the wind farms;

(1-13) establishing constraints on a total upward reserve capacity and a total downward reserve capacity of the power system:

$${\sum }_{i ∈ {I}^{B}} {r}_{i , t}^{B , u} + {\sum }_{{i}_{G} ∈ {I}^{G}} {r}_{{i}_{G} , t}^{G , u} \geq {r}_{t}^{sys , u} , t ∈ [ 1 , T ]$$

$${\sum }_{i ∈ {I}^{B}} {r}_{i , t}^{B , d} + {\sum }_{{i}_{G} ∈ {I}^{G}} {r}_{{i}_{G} , t}^{G , d} \geq {r}_{t}^{sys , d} , t ∈ [ 1 , T ]$$

where r_{i,t}^{B,u} is an upward reserve capacity provided by a voltage sensitive load at the node i at the dispatching time point t, r_{i,t}^{B,d} is a downward reserve capacity provided by a voltage sensitive load at the node i at the dispatching time point t, rₜ^{sys,u} is a total upward reserve capacity needed by the power system at the dispatching time point t, and rₜ^{sys,d} is a total downward reserve capacity needed by the power system at the dispatching time point t;

(1-14) establishing a constraint on a reserve capacity of the voltage sensitive load:

$${r}_{i , t}^{B , u} \leq Δ {P}_{i , t}^{{L}^{′}} = {P}_{i , t}^{B} ( 2 {a}_{i , t}^{p} \frac{Δ {U}_{i , t}^{{pf}^{′}}}{{U}_{N}^{pf}} + {b}_{i , t}^{p} ) , i ∈ {I}^{B} , t ∈ [ 1 , T ]$$

$${r}_{i , t}^{B , d} \leq Δ {P}_{i , t}^{{L}^{″}} = {P}_{i , t}^{B} ( 2 {a}_{i , t}^{p} \frac{Δ {U}_{i , t}^{{pf}^{″}}}{{U}_{N}^{pf}} + {b}_{i , t}^{p} ) , i ∈ {I}^{B} , t ∈ [ 1 , T ]$$

where ΔP_{i,t}^{L′} is a variation of the active power of the load at the node i at the dispatching time point t when the voltage sensitive load provides the upward reserve capacity, U_{i,t}^{p f′} is a variation of the voltage magnitude of the node i at the dispatching time point t when the voltage sensitive load provides the upward reserve capacity, ΔP_{i,t}^{L″} is a variation of the active power of the load at the node i at the dispatching time point t when the voltage sensitive load provides the downward reserve capacity, and ΔU_{i,t}^{p f″} is a variation of the voltage magnitude of the node i at the dispatching time point t when the voltage sensitive load provides the downward reserve capacity;

(2) establishing an evaluation model of a voltage sensitive load regulation range:

(2-1) establishing a first variable regulation model in the power system when the voltage sensitive load provides the upward reserve capacity:

(2-1-1) establishing a set Ω^{Δ′} of regulated variables in the power system when the voltage sensitive load provides the upward reserve capacity: 1

Ω^{Δ′}={ΔPᵢ_{_{G}}_{,t}^{G′},ΔQᵢ_{_{G}}_{,t}^{G′},ΔP_{i,t}^{p f′},ΔQ_{i,t}^{p f′},ΔU_{i,t}^{p f′},Δδ_{i,t}^{p f′},ΔI_{ij,t}^{p f′},ΔL_{i,t}′}

where ΔPᵢ_{_{G}}_{,t}^{G′} is a variation of the active power of the generator i_{G} at the dispatching time point t when the voltage sensitive load provides the upward reserve capacity, ΔQᵢ_{_{G}}_{,t}^{G′} is a variation of the reactive power of the generator i_{G} at the dispatching time point t when the voltage sensitive load provides the upward reserve capacity, ΔP_{i,t}^{p f′} is a variation of the active power injected at the node i at the dispatching time point t when the voltage sensitive load provides the upward reserve capacity, ΔQ_{i,t}^{p f′} is a variation of the reactive power injected at the node i at the dispatching time point t when the voltage sensitive load provides the upward reserve capacity, ΔU_{i,t}^{p f′} is a variation of the voltage magnitude of the node i at the dispatching time point t when the voltage sensitive load provides the upward reserve capacity, Δδ_{i,t}^{p f′} is a variation of the voltage phase angle of the node i at the dispatching time point t when the voltage sensitive load provides the upward reserve capacity, ΔI_{ij,t}^{p f′} is a variation of the current in the power line between the node i and the node j at the dispatching time point t when the voltage sensitive load provides the upward reserve capacity, and ΔL_{i,t}′ is a variation of the voltage stability index of the node i when the voltage sensitive load provides the upward reserve capacity;

(2-1-2) establishing a constraint among the variations of the active power, the reactive power, the voltage magnitudes and the voltage phase angles injected at respective nodes:

$$[ \begin{matrix}Δ {P}_{t}^{{pf}^{′}} \\ Δ {Q}_{t}^{{pf}^{′}}\end{matrix} ] = {J}^{pf} [ \begin{matrix}{Δδ}_{t}^{{pf}^{′}} \\ Δ {U}_{t}^{{pf}^{′}} \text{/} {U}_{t}^{pf}\end{matrix} ]$$

where ΔPₜ^{p f′} is a column vector constituted by the variations ΔP_{i,t}^{p f′} of the active power injected at respective nodes i at the dispatching time point t when the voltage sensitive load provides the upward reserve capacity, ΔQₜ^{p f′} is a column vector constituted by the variations ΔQ_{i,t}^{p f′} of the reactive power injected at respective nodes i at the dispatching time point t when the voltage sensitive load provides the upward reserve capacity, Δδₜ^{p f′} is a column vector constituted by the variations Δδ_{i,t}^{p f′} of the voltage phase angles of the respective nodes i at the dispatching time point t when the voltage sensitive load provides the upward reserve capacity, ΔUₜ^{p f′} is a column vector constituted by the variations ΔU_{i,t}^{p f′} of the voltage magnitude of the respective nodes i at the dispatching time point t when the voltage sensitive load provides the upward reserve capacity, J^{p f} is a Jacobian matrix of power flow equation, which is obtained from the energy management system of the electro-thermal coupling multi-energy flow system;

(2-1-3) establishing constraints on the variations of the active power and the reactive power injected at respective nodes:

$$Δ {P}_{i , t}^{{pf}^{′}} = - Δ {P}_{i , t}^{{L}^{′}} + ΣΔ {P}_{{i}_{G} , t}^{{G}^{′}} , i ∈ {I}^{B} , t ∈ [ 1 , T ]$$

$$Δ {Q}_{i , t}^{{pf}^{′}} = - Δ {Q}_{i , t}^{{L}^{′}} + ΣΔ {Q}_{{i}_{G} , t}^{{G}^{′}} , i ∈ {I}^{B} , t ∈ [ 1 , T ] \\ - {R}_{{i}_{G}}^{G , d} \leq Δ {P}_{{i}_{G} , t}^{{G}^{′}} \leq {R}_{{i}_{G}}^{G , u} , {i}_{G} ∈ {I}^{G} , t ∈ [ 1 , T ]$$

where ΔP_{i,t}^{L′} is a variation of the active power of the load at the node i at the dispatching time point t when the voltage sensitive load provides the upward reserve capacity, and ΔQ_{i,t}^{L′} is a variation of the reactive power of the load at the node i at the dispatching time point t when the voltage sensitive load provides the upward reserve capacity;

(2-1-4) establishing a constraint equation of the variation of the current in the power line:

$${( {I}_{ij , t}^{pf} )}^{2} + Δ {I}_{ij , t}^{{pf}^{′}} \leq {( {I}_{ij}^{pf , max} )}^{2} , i ∈ {I}^{B} , j ∈ {I}^{B} , t ∈ [ 1 , T ]$$

$$Δ {I}_{ij , t}^{{pf}^{′}} = 2 {I}_{ij , t}^{pf} [ \frac{\partial {I}_{ij , t}^{pf}}{\partial {U}^{pf}} \frac{\partial {I}_{ij , t}^{pf}}{\partial {δ}^{pf}} ] [ \begin{matrix}Δ {U}_{t}^{{pf}^{′}} \\ {Δδ}_{t}^{{pf}^{′}}\end{matrix} ] , i ∈ {I}^{B} , j ∈ {I}^{B} , t ∈ [ 1 , T ]$$

where U^{p f} is a voltage magnitude,

$$\frac{\partial {I}_{ij , t}^{pf}}{\partial {U}^{pf}}$$

is a sensitivity of I_{ij,t}^{p f} to the voltage magnitude, and is obtained from the energy management system of the electro-thermal coupling multi-energy flow system, δ^{p f} is a voltage phase angle, and

$$\frac{\partial {I}_{ij , t}^{pf}}{\partial {δ}^{pf}}$$

is a sensitivity of I_{ij,t}^{p f} to the voltage phase angle, and is obtained from the energy management system of the electro-thermal coupling multi-energy flow system;

(2-1-5) establishing constraints on the voltage magnitude and the voltage phase angle:

Uᵢ^{p f,min}≤U_{i,t}^{p f}+Δ_{i,t}^{p f′}≤Uᵢ^{p f,max},i∈I^{B},t∈[1,T]

δᵢ^{p f,min}≤δ_{i,t}^{p f}+Δδ_{i,t}^{p f′}≤δᵢ^{p f,max},i∈I^{B},t∈[1,T]

(2-1-6) establishing constraints on the active power and the reactive power of the generator:

Pᵢ_{_{G}}^{G,min}≤Pᵢ_{_{G}}_{,t}^{G}+ΔPᵢ_{_{G}}_{,t}^{G′}≤Pᵢ_{_{G}}^{G,max},i_{G}∈I^{G},t∈[1,T]

Qᵢ_{_{G}}^{G,min}≤Qᵢ_{_{G}}_{,t}^{G}+ΔQᵢ_{_{G}}_{,t}^{G′}≤Qᵢ_{_{G}}^{G,max},i_{G}∈I^{G},t∈[1,T]

(2-1-7) establishing constraints on the variations of the active power and the reactive power of the load:

$$Δ {P}_{i , t}^{{L}^{′}} = {P}_{i , t}^{B} ( 2 {a}_{i , t}^{p} \frac{Δ {U}_{i , t}^{{pf}^{′}}}{{U}_{N}^{pf}} + {b}_{i , t}^{p} ) , i ∈ {I}^{B} , t ∈ [ 1 , T ]$$

$$Δ {Q}_{i , t}^{{L}^{′}} = {Q}_{i , t}^{B} ( 2 {a}_{i , t}^{q} \frac{Δ {U}_{i , t}^{{pf}^{′}}}{{U}_{N}^{pf}} + {b}_{i , t}^{q} + 2 {Q}_{i , t}^{FC} \frac{Δ {U}_{i , t}^{{pf}^{′}}}{{U}_{N}^{pf}} ) , i ∈ {I}^{B} , t ∈ [ 1 , T ]$$

(2-1-8) establishing a voltage stability index constraint equation:

$${L}_{i , t} + Δ {L}_{i , t}^{′} \leq {L}^{max}$$

$$Δ {L}_{i , t}^{′} = [ \frac{\partial L}{\partial {U}_{t}^{pf}} \frac{\partial L}{\partial {δ}_{t}^{pf}} ] [ \begin{matrix}Δ {U}_{t}^{{pf}^{′}} \\ {Δδ}_{t}^{{pf}^{′}}\end{matrix} ]$$

where

$$\frac{\partial L}{\partial {U}_{t}^{pf}}$$

is a sensitivity of the voltage stability index to the voltage magnitude, and is obtained from the energy management system of the electro-thermal coupling multi-energy flow system;

$$\frac{\partial L}{\partial {δ}_{t}^{pf}}$$

is a sensitivity of the voltage stability index to the voltage phase angle, and is obtained from the energy management system of the electro-thermal coupling multi-energy flow system;

(2-2) establishing a second variable regulation model in the power system when the voltage sensitive load provides the downward reserve capacity:

(2-2-1) establishing a set Ω^{Δ″} of regulated variables in the power system when the voltage sensitive load provides the downward reserve capacity:

Ω^{Δ″}={ΔPᵢ_{_{G}}_{,t}^{G″},ΔQᵢ_{_{G}}_{,t}^{G″},ΔP_{i,t}^{p f″},ΔQ_{i,t}^{p f″},ΔU_{i,t}^{p f″},Δδ_{i,t}^{p f″},ΔI_{ij,t}^{p f″},ΔL_{i,t}″}

where ΔPᵢ_{_{G}}_{,t}^{G″} is a variation of the active power of the generator i_{G} at the dispatching time point t when the voltage sensitive load provides the downward reserve capacity, ΔQᵢ_{_{G}}_{,t}^{G″} is a variation of the reactive power of the generator i_{G} at the dispatching time point t when the voltage sensitive load provides the downward reserve capacity, ΔP_{i,t}^{p f″} is a variation of the active power injected at the node i at the dispatching time point t when the voltage sensitive load provides the downward reserve capacity, ΔQ_{i,t}^{p f″} is a variation of the reactive power injected at the node i at the dispatching time point t when the voltage sensitive load provides the downward reserve capacity, ΔU_{i,t}^{p f″} is a variation of the voltage magnitude of the node i at the dispatching time point t when the voltage sensitive load provides the downward reserve capacity, Δδ_{i,t}^{p f″} is a variation of the voltage phase angle of the node i at the dispatching time point t when the voltage sensitive load provides the downward reserve capacity, ΔI_{ij,t}^{p f″} is a variation of the current in the power line between the node i and the node j at the dispatching time point t when the voltage sensitive load provides the downward reserve capacity, and ΔL_{i,t}″ is a variation of the voltage stability index of the node i when the voltage sensitive load provides the downward reserve capacity;

(2-2-2) establishing a constraint among the variations of the active power, the reactive power, the voltage magnitudes and the voltage phase angles injected at respective nodes:

$$[ \begin{matrix}Δ {P}_{t}^{{pf}^{″}} \\ Δ {Q}_{i}^{{pf}^{″}}\end{matrix} ] = {J}^{pf} [ \begin{matrix}{Δδ}_{t}^{{pf}^{″}} \\ Δ {U}_{t}^{{pf}^{″}} \text{/} {U}_{t}^{pf}\end{matrix} ]$$

where ΔPₜ^{p f″} is a column vector constituted by the variations ΔP_{i,t}^{p f″} of the active power injected at respective nodes i at the dispatching time point t when the voltage sensitive load provides the downward reserve capacity, ΔQₜ^{p f″} is a column vector constituted by the variations ΔQ_{i,t}^{p f″} of the reactive power injected at respective nodes i at the dispatching time point t when the voltage sensitive load provides the downward reserve capacity, Δδₜ^{p f″} is a column vector constituted by the variations Δδ_{i,t}^{p f″} of the voltage phase angles of the respective nodes i at the dispatching time point t when the voltage sensitive load provides the downward reserve capacity, and ΔUₜ^{p f″} is a column vector constituted by the variations ΔU_{i,t}^{p f″} of the voltage magnitude of the respective nodes i at the dispatching time point t when the voltage sensitive load provides the downward reserve capacity;

(2-2-3) establishing constraints on the variations of the active power and the reactive power injected at respective nodes:

$$Δ {P}_{i , t}^{{pf}^{″}} = - Δ {P}_{i , t}^{{L}^{″}} + ΣΔ {P}_{{i}_{G} , t}^{{G}^{″}} , i ∈ {I}^{B} , t ∈ [ 1 , T ]$$

$$Δ {Q}_{i , t}^{{pf}^{″}} = - Δ {Q}_{i , t}^{{L}^{″}} + ΣΔ {Q}_{{i}_{G} , t}^{{G}^{″}} , i ∈ {I}^{B} , t ∈ [ 1 , T ] \\ - {R}_{{i}_{G}}^{G , d} \leq Δ {P}_{{i}_{G} , t}^{{G}^{″}} \leq {R}_{{i}_{G}}^{G , u} , {i}_{G} ∈ {I}^{G} , t ∈ [ 1 , T ]$$

where ΔP_{i,t}^{L″} is a variation of the active power of the load at the node i at the dispatching time point t when the voltage sensitive load provides the downward reserve capacity, and ΔQ_{i,t}^{L″} is a variation of the reactive power of the load at the node i at the dispatching time point t when the voltage sensitive load provides the downward reserve capacity;

(2-2-4) establishing a constraint on the variation of the current in the power line:

$${( {I}_{ij , t}^{pf} )}^{2} + Δ {I}_{ij , t}^{{pf}^{″}} \leq {( {I}_{ij}^{pf , max} )}^{2} , i ∈ {I}^{B} , j ∈ {I}^{B} , t ∈ [ 1 , T ]$$

$$Δ {I}_{ij , t}^{{pf}^{″}} = 2 {I}_{ij , t}^{pf} [ \frac{\partial {I}_{ij , t}^{pf}}{\partial {U}^{pf}} \frac{\partial {I}_{ij , t}^{pf}}{\partial {δ}^{pf}} ] [ \begin{matrix}Δ {U}_{t}^{{pf}^{″}} \\ {Δδ}_{t}^{{pf}^{″}}\end{matrix} ] , i ∈ {I}^{B} , j ∈ {I}^{B} , t ∈ [ 1 , T ]$$

(2-2-5) establishing constraints on the voltage magnitude and the voltage phase angle:

Uᵢ^{p f,min}≤U_{i,t}^{p f}+ΔU_{i,t}^{p f″}≤Uᵢ^{p f,max},i∈I^{B},t∈[1,T]

δᵢ^{p f,min}≤δ_{i,t}^{p f}+Δδ_{i,t}^{p f″}≤δᵢ^{p f,max},i∈I^{B},t∈[1,T]

(2-2-6) establishing constraints on the active power and the reactive power of the generator:

Pᵢ_{_{G}}^{G,min}≤Pᵢ_{_{G}}_{,t}^{G}+ΔPᵢ_{_{G}}_{,t}^{G″}≤Pᵢ_{_{G}}^{G,max},i_{G}∈I^{G},t∈[1,T]

Qᵢ_{_{G}}^{G,min}≤Qᵢ_{_{G}}_{,t}^{G}+ΔQᵢ_{_{G}}_{,t}^{G″}≤Qᵢ_{_{G}}^{G,max},i_{G}∈I^{G},t∈[1,T]

(2-2-7) establishing constraints on the variations of the active power and the reactive power of the load:

$$Δ {P}_{i , t}^{{L}^{″}} = {P}_{i , t}^{B} ( 2 {a}_{i , t}^{p} \frac{Δ {U}_{i , t}^{{pf}^{″}}}{{U}_{N}^{pf}} + {b}_{i , t}^{p} ) , i ∈ {I}^{B} , t ∈ [ 1 , T ]$$

$$Δ {Q}_{i , t}^{{L}^{″}} = {Q}_{i , t}^{B} ( 2 {a}_{i , t}^{q} \frac{Δ {U}_{i , t}^{{pf}^{″}}}{{U}_{N}^{pf}} + {b}_{i , t}^{q} + 2 {Q}_{i , t}^{FC} \frac{Δ {U}_{i , t}^{{pf}^{″}}}{{U}_{N}^{pf}} ) , i ∈ {I}^{B} , t ∈ [ 1 , T ]$$

(2-2-8) establishing a voltage stability index constraint equation:

$${L}_{i , t} + Δ {L}_{i , t}^{″} \leq {L}^{max}$$

$$Δ {L}_{i , t}^{″} = [ \frac{\partial L}{\partial {U}_{t}^{pf}} \frac{\partial L}{\partial {δ}_{t}^{pf}} ] [ \begin{matrix}Δ {U}_{t}^{{pf}^{″}} \\ {Δδ}_{t}^{{pf}^{″}}\end{matrix} ]$$

(3) establishing an optimization objective of power system dispatch:

min F^{G}(Pₜ^{G},rₜ^{G,u},rₜ^{G,d})+F^{P}(Pₜ^{wd},Pₜ^{lc})−F^{B}(Pₜ^{L})

where Pₜ^{G} is a column vector constituted by the active power Pᵢ_{_{G}}_{,t}^{G} of all the generators in the power system, rₜ^{G,u} is a column vector constituted by the upward reserve capacities rᵢ_{_{G}}_{,t}^{G,u} provided by all the generators in the power system, rₜ^{G,d} is a column vector constituted by the downward reserve capacities rᵢ_{_{G}}_{,t}^{G,d} provided by all the generators in the power system, F^{G}(Pₜ^{G},rₜ^{G,u},rₜ^{G,d}) is the cost of providing the active power and reserve capacities by all the generators in the power system, Pₜ^{wd} is a column vector constituted by the active power Pᵢ_{_{W}}_{,t}^{wd} abandoned by all the wind farms in the power system, Pₜ^{lc} is a column vector constituted by the active power P_{i,t}^{lc} of all the removed loads in the power system, F^{P}(Pₜ^{wd},Pₜ^{lc}) is the cost of abandoned wind farms and the removed loads in the power system, Pₜ^{L} is a column vector constituted by the active power P_{i,t}^{L} of all the electrical loads in the power system, and F^{B} (Pₜ^{L}) is sales revenue of the power system; and

(4) constructing an optimized power system dispatching model considering the voltage sensitive load reserve by the ground state operating point model of the power system established in step (1), the evaluation model of the voltage sensitive load regulation range established in step (2) and the optimization objective of power system dispatch established in step (3), solving the optimized power system dispatching model by an interior point method to obtain dispatching parameters of the power system, including the active power Pᵢ_{_{G}}_{,t}^{G} of the generator i_{G}, the reactive power Qᵢ_{_{G}}_{,t}^{G} of the generator i_{G}, the active power P_{i,t}^{L} of the load at the node i, and the reactive power Q_{i,t}^{L} of the load at the node i, to complete power system dispatching considering voltage sensitive load reserve.

In some embodiments of the present disclosure, the optimized power system dispatching model is solved by an Ipopt solver.

With the power system dispatching method considering voltage sensitive load reserve according to embodiments of the present disclosure, a power system dispatching model constituted by a ground state operating point model of the power system, the evaluation model of the voltage sensitive load regulation range and the optimization objective of power system dispatch is established, by solving the power system dispatching model, a power system dispatching solution considering voltage sensitive load reserve is obtained. This method can make full use of the regulation ability of voltage sensitive load to supplement the reserve capacity of the power system and help the power system to control the active power. Further, the method of the present disclosure can maximize the sales revenue of the power system on the premise of meeting the voltage stability index constraint, and ensure the safe and economic operation of the power system.

The present disclosure provides in embodiments a power system dispatching device considering voltage sensitive load reserve. The device includes a processor, and a memory having stored therein a computer program that, when executed by the processor, causes the processor to perform the present method as described above.

It should be noted that all of the above features and advantages described for the method are also applicable to the device, which will not be elaborated herein.

The present disclosure provides in embodiments a non-transitory computer-readable storage medium having stored therein instructions that, when executed by a processor, causes the processor to perform the present method as described above.

It should be noted that various embodiments or examples described in the specification, as well as features of such the embodiments or examples, may be combined without conflict. Besides above examples, any other suitable combination should be regarded in the scope of the present disclosure.

Reference throughout this specification to “an embodiment”, “some embodiments”, “one embodiment”, “another example”, “an example”, “a specific example” or “some examples” means that a particular feature, structure, material, or characteristic described in connection with the embodiment or example is included in at least one embodiment or example of the present disclosure. Thus, the appearances of the phrases such as “in some embodiments”, “in one embodiment”, “in an embodiment”, “in another example”, “in an example” “in a specific example” or “in some examples” in various places throughout this specification are not necessarily referring to the same embodiment or example of the present disclosure. Furthermore, the particular features, structures, materials, or characteristics may be combined in any suitable manner in one or more embodiments or examples.

It should be noted that, in this context, relational terms such as first and second are used only to distinguish an entity from another entity or to distinguish an operation from another operation without necessarily requiring or implying that the entities or operations actually have a certain relationship or sequence. Moreover, “comprise”, “include” or other variants are non-exclusive, thus a process, a method, an object or a device including a series of elements not only include such elements, but also include other elements which may not mentioned, or inherent elements of the process, method, object or device. If there is no further limitation, a feature defined by an expression of “include a . . . ” does not mean the process, the method, the object or the device can only have one elements, same elements may also be included.

It should be noted that, although the present disclosure has been described with reference to the embodiments, it will be appreciated by those skilled in the art that the disclosure includes other examples that occur to those skilled in the art to execute the disclosure. Therefore, the present disclosure is not limited to the embodiments.

Any process or method described herein in other ways may be understood to include one or more modules, segments or portions of codes of executable instructions for achieving specific logical functions or steps in the process, and the scope of a preferred embodiment of the present disclosure includes other implementations, which may not follow a shown or discussed order according to the related functions in a substantially simultaneous manner or in a reverse order, to perform the function, which should be understood by those skilled in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system including processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium include but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs include one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks, CD, etc.

Although explanatory embodiments have been shown and described, it would be appreciated by those skilled in the art that the above embodiments cannot be construed to limit the present disclosure, and changes, alternatives, and modifications can be made in the embodiments without departing from scope of the present disclosure.

What is claimed is:

1. A power system dispatching method considering voltage sensitive load reserve, comprising:
(1) establishing a ground state operating point model of a power system:
(1-1) establishing a variable set Q of the ground state operating point model of the power system:
Ω={Pᵢ_{_{G}}_{,t}^{G},rᵢ_{_{G}}_{,t}^{G,u},rᵢ_{_{G}}_{,t}^{G,d},Qᵢ_{_{G}}_{,t}^{G},P_{i,t}^{p f},Q_{i,t}^{p f},U_{i,t}^{p f},δ_{i,t}^{p f},P_{i,t}^{L},Q_{i,t}^{L},L_{i,t}},
where i_{G} is a serial number of a generator, t is a dispatching time point, Pᵢ_{_{G}}_{,t}^{G} is active power of the generator i_{G} at the dispatching time point t, rᵢ_{_{G}}_{,t}^{G,u} is an upward reserve capacity supplied by the generator i_{G} at the dispatching time point t, rᵢ_{_{G}}_{,t}^{G,d} is a downward reserve capacity supplied by the generator i_{G} at the dispatching time point t, Qᵢ_{_{G}}_{,t}^{G} is reactive power of the generator i_{G} at the dispatching time point t, i is a serial number of a node, P_{i,t}^{p f} is active power injected at the node i at the dispatching time point t, Q_{i,t}^{p f} is reactive power injected at the node i at the dispatching time point t, U_{i,t}^{p f} is a voltage magnitude of the node i at the dispatching time point t, δ_{i,t}^{p f} is a voltage phase angle of the node i at the dispatching time point t, j is a serial number of a node connected to the node i, I_{ij,t}^{p f} is a current in a power line between the node i and the node j at the dispatching time point t, P_{i,t}^{L} is active power of a load at the node i at the dispatching time point t, Q_{i,t}^{L} is reactive power of the load at the node i at the dispatching time point t, and L_{i,t} is a voltage stability index of the node i at the dispatching time point t;
(1-2) establishing a constraint on the active power of the generator:
Pᵢ_{_{G}}^{G,min}≤Pᵢ_{_{G}}_{,t}^{G}≤Pᵢ_{_{G}}^{G,max},∀i_{G}∈I^{G},t∈[1,T]
where Pᵢ_{_{G}}^{G,min} is a lower limit of the active power of the generator i_{G}, Pᵢ_{_{G}}^{G,max} is an upper limit of the active power of the generator i_{G}, I^{G} is a set constituted by all the generators, and T is the total number of dispatching time points;
(1-3) establishing constraints on a reserve capacity and a ramp rate of the generator:
0≤rᵢ_{_{G}}_{,t}^{G,u}≤Pᵢ_{_{G}}^{G,max}−Pᵢ_{_{G}}_{,t}^{G},∀i_{G}∈I^{G},t∈[1,T]
0≤rᵢ_{_{G}}_{,t}^{G,d}≤Pᵢ_{_{G}}_{,t}^{G}−Pᵢ_{_{G}}^{G,min},∀i_{G}∈I^{G},t∈[1,T]
(Pᵢ_{_{G}}_{,t}^{G}+rᵢ_{_{G}}_{,t}^{G,u})−(Pᵢ_{_{G}}_{,t+1}^{G}−rᵢ_{_{G}}_{,t+1}^{G,d})≤Rᵢ_{_{G}}^{G,d},∀i_{G}∈I^{G},∀t∈[1,T−1]
(Pᵢ_{_{G}}_{,t+1}^{G}+rᵢ_{_{G}}_{,t+1}^{G,u})−(Pᵢ_{_{G}}_{,t}^{G}−rᵢ_{_{G}}_{,t}^{G,d})≤Rᵢ_{_{G}}^{G,u},∀i_{G}∈I^{G},∀t∈[1,T−1]
where Pᵢ_{_{G}}_{,t+1}^{G} is active power of the generator i_{G} at a dispatching time point t+1, rᵢ_{_{G}}_{,t+1}^{G,d} is an upward reserve capacity supplied by the generator i_{G} at the dispatching time point t+1, Rᵢ_{_{G}}^{G,d} is a downward ramp rate of the generator i_{G}, and Rᵢ_{_{G}}^{G,u} is an upward ramp rate of the generator i_{G};
(1-4) establishing a constraint on the reactive power of the generator:
Qᵢ_{_{G}}^{G,min}≤Qᵢ_{_{G}}_{,t}^{G}≤Qᵢ_{_{G}}^{G,max},∀i_{G}∈I^{G},t∈[1,T]
where Qᵢ_{_{G}}^{G,min} is a lower limit of the reactive power of the generator i_{G}, and Qᵢ_{_{G}}^{G,max} is an upper limit of the reactive power of the generator i_{G};
(1-5) establishing a constraint on power system load flow:
$${P}_{i , t}^{pf} = {\sum }_{j ∈ {I}^{B}} {U}_{i , t}^{pf} {U}_{j , t}^{pf} ( {G}_{ij}^{pf} cos {δ}_{ij , t}^{pf} + {B}_{ij}^{pf} sin {δ}_{ij , t}^{pf} ) , ∀ i ∈ {I}^{B} , t ∈ [ 1 , T ]$$
$${Q}_{i , t}^{pf} = {\sum }_{j ∈ {I}^{B}} {U}_{i , t}^{pf} {U}_{j , t}^{pf} ( {G}_{ij}^{pf} sin {δ}_{ij , t}^{pf} - {B}_{ij}^{pf} cos {δ}_{ij , t}^{pf} ) , ∀ i ∈ {I}^{B} , t ∈ [ 1 , T ]$$
$${δ}_{ij , t}^{pf} = {δ}_{i , t}^{pf} - {δ}_{j , t}^{pf} , ∀ i ∈ {I}^{B} , t ∈ [ 1 , T ]$$
$${( {I}_{ij , t}^{pf} )}^{2} = \frac{{( {P}_{i , t}^{pf} )}^{2} + {( {Q}_{i , t}^{pf} )}^{2}}{{( {U}_{i , t}^{pf} )}^{2}} , ∀ i ∈ {I}^{B} , t ∈ [ 1 , T ]$$
where I^{B} is a set of all the buses in the power system, U_{j,t}^{p f} is a voltage magnitude of the node j at the dispatching time t, Gᵢⱼ^{p f} is a real part of an element in line i and column j of a power network node admittance matrix Y, Bᵢⱼ^{p f} is an imaginary part of the element in line i and column j of the power network node admittance matrix Y, wherein the power network node admittance matrix Y is acquired from an energy management system of an electro-thermal coupling multi-energy flow system, and δ_{ij,t}^{p f} is a voltage phase angle difference between the node i and the node j at the dispatching time t;
(1-6) establishing a constraint on a line capacity:
(I_{ij,t}^{p f})²≤(Iᵢⱼ^{p f,max})²,∀i,j∈I^{B},t∈[1,T]
where Iᵢⱼ^{p f,max} is an upper limit of the current in the power line between the node i and the node j;
(1-7) establishing constraints on the voltage magnitude and voltage phase angle of the node:
Uᵢ^{p f,min}≤U_{i,t}^{p f}≤Uᵢ^{p f,max},i∈I^{B},t∈[1,T]
δᵢ^{p f,min}≤δ_{i,t}^{p f}≤δᵢ^{p f,max},i∈I^{B},t∈[1,T]
where Uᵢ^{p f,min} is a lower limit of the voltage magnitude of the node i, Uᵢ^{p f,max} is an upper limit of the voltage magnitude of the node i, δᵢ^{p f,min} is a lower limit of the voltage phase angle of the node i, and δᵢ^{p f,max} is an upper limit of the voltage phase angle of the node i;
(1-8) establishing constraints on the active power and the reactive power injected at the node:
$${P}_{i , t}^{pf} = - {P}_{i , t}^{L} + {P}_{i , t}^{lc} + {\sum }_{{i}_{G} ∈ {I}_{i}^{G}} {P}_{{i}_{G} , t}^{G} + {\sum }_{{i}_{W} ∈ {I}_{i}^{W}} {P}_{{i}_{W} , t}^{W} , ∀ i ∈ {I}^{B} , t ∈ [ 1 , T ]$$
$${Q}_{i , t}^{pf} = - {Q}_{i , t}^{L} + {Q}_{i , t}^{lc} + {\sum }_{{i}_{G} ∈ {I}_{i}^{G}} {Q}_{{i}_{G} , t}^{G} , ∀ i ∈ {I}^{B} , t ∈ [ 1 , T ]$$
where P_{i,t}^{lc} is active power of a removed load at the node i at the dispatching time point t, Iᵢ^{G} is a set constituted by all the generators connected at the node i, i_{W} is a serial number of a wind farm, Iᵢ^{W} is a set constituted by all the wind farms connected at the node i, Pᵢ_{_{W}}_{,t}^{W} is active power of the wind farm i_{W} at the dispatching time point t, and Q_{i,t}^{lc} is reactive power of the removed load at the node i at the dispatching time point t;
(1-9) establishing a constraint on the active power of the removed load:
0≤P_{i,t}^{lc}≤P_{i,t}^{L},∀i∈I^{B},t∈[1,T]
(1-10) establishing constraints on active power, reactive power and a voltage magnitude of a load:
$${P}_{i , t}^{L} = {P}_{i , t}^{B} ( {{a}_{i , t}^{p} ( \frac{{U}_{i , t}^{pf}}{{U}_{N}^{pf}} )}^{2} + {b}_{i , t}^{p} \frac{{U}_{i , t}^{pf}}{{U}_{N}^{pf}} + {c}_{i , t}^{p} ) , i ∈ {I}^{B} , t ∈ [ 1 , T ]$$
$${Q}_{i , t}^{L} = {Q}_{i , t}^{B} ( {{a}_{i , t}^{q} ( \frac{{U}_{i , t}^{pf}}{{U}_{N}^{pf}} )}^{2} + {b}_{i , t}^{q} \frac{{U}_{i , t}^{pf}}{{U}_{N}^{pf}} + {c}_{i , t}^{q} ) + {{Q}_{i , t}^{FC} ( \frac{{U}_{i , t}^{pf}}{{U}_{N}^{pf}} )}^{2} , i ∈ {I}^{B} , t ∈ [ 1 , T ]$$
where P_{i,t}^{B} is active power of the node i under a rated voltage at the dispatching time point t, U_{N}^{p f} is the rated voltage, a_{i,t}^{p}. b_{i,t}^{p} and c_{i,t}^{p} are a second-order coefficient, a first-order coefficient and a constant term of a node injected active power model, respectively, Q_{i,t}^{B} is reactive power of the node i under the rated voltage at the dispatching time point t, Q_{i,t}^{FC} is a capacity of a reactive power compensation device input at the node i at the dispatching time point t, and a_{i,t}^{q}, b_{i,t}^{q} and c_{i,t}^{q} are a second-order coefficient, a first-order coefficient and a constant term of a node injected reactive power model, respectively;
(1-11) establishing a range constraint on the voltage stability index:
$${L}_{i , t} = \vert 1 - \frac{{\sum }_{j ∈ {𝒥}^{G}} {F}_{ij} {U}_{j}^{pf}}{{U}_{i}^{pf}} \vert , i ∈ {I}^{B} , t ∈ [ 1 , T ]$$
$${L}_{i , t} \leq {L}^{max} , i ∈ {I}^{B} , t ∈ [ 1 , T ]$$
where ϑ^{G} represents a set of nodes connected to a generator, Fᵢⱼ is a submatrix of a hybrid parameter matrix, and L^{max} is an upper limit of the voltage stability index;
(1-12) establishing constraints on the active power and abandoned active power of the wind farm:
0≤Pᵢ_{_{W}}_{,t}^{W}≤Pᵢ_{_{W}}_{,t}^{W,F},∀i_{W}∈I^{W},t∈[1,T]
Pᵢ_{_{W}}_{,t}^{wd}=Pᵢ_{_{W}}_{,t}^{W,F}−Pᵢ_{_{W}}_{,t}^{W},∀i_{W}∈I^{W},t∈[1,T]
where Pᵢ_{_{W}}_{,t}^{W,F} is a predicted value of the active power of the wind farm i_{W} at the dispatching time point t, Pᵢ_{_{W}}_{,t}^{wd} is the abandoned active power of the wind farm i_{W} at the dispatching time point t, and I^{W} is a set constituted by all the wind farms;
(1-13) establishing constraints on a total upward reserve capacity and a total downward reserve capacity of the power system:
$${\sum }_{i ∈ {I}^{B}} {r}_{i , t}^{B , u} + {\sum }_{{i}_{G} ∈ {I}^{G}} {r}_{{i}_{G} , t}^{G , u} \geq {r}_{t}^{sys , u} , t ∈ [ 1 , T ]$$
$${\sum }_{i ∈ {I}^{B}} {r}_{i , t}^{B , d} + {\sum }_{{i}_{G} ∈ {I}^{G}} {r}_{{i}_{G} , t}^{G , d} \geq {r}_{t}^{sys , d} , t ∈ [ 1 , T ]$$
where r_{i,t}^{B,u} is an upward reserve capacity provided by a voltage sensitive load at the node i at the dispatching time point t, r_{i,t}^{B,d} is a downward reserve capacity provided by a voltage sensitive load at the node i at the dispatching time point t, rᵢ^{sys,u} is a total upward reserve capacity needed by the power system at the dispatching time point t, and rᵢ^{sys,d} is a total downward reserve capacity needed by the power system at the dispatching time point t;
(1-14) establishing a constraint on a reserve capacity of the voltage sensitive load:
$${r}_{i , t}^{B , u} \leq Δ {P}_{i , t}^{{L}^{′}} = {P}_{i , t}^{B} ( 2 {a}_{i , t}^{p} \frac{Δ {U}_{i , t}^{{pf}^{′}}}{{U}_{N}^{pf}} + {b}_{i , t}^{p} ) , i ∈ {I}^{B} , t ∈ [ 1 , T ]$$
$${r}_{i , t}^{B , d} \leq Δ {P}_{i , t}^{{L}^{″}} = {P}_{i , t}^{B} ( 2 {a}_{i , t}^{p} \frac{Δ {U}_{i , t}^{{pf}^{″}}}{{U}_{N}^{pf}} + {b}_{i , t}^{p} ) , i ∈ {I}^{B} , t ∈ [ 1 , T ]$$
where ΔP_{i,t}^{L′} is a variation of the active power of the load at the node i at the dispatching time point t when the voltage sensitive load provides the upward reserve capacity, U_{i,t}^{p f′} is a variation of the voltage magnitude of the node i at the dispatching time point t when the voltage sensitive load provides the upward reserve capacity, ΔP_{i,t}^{L″} is a variation of the active power of the load at the node i at the dispatching time point t when the voltage sensitive load provides the downward reserve capacity, and ΔU_{i,t}^{p f″} is a variation of the voltage magnitude of the node i at the dispatching time point t when the voltage sensitive load provides the downward reserve capacity;
(2) establishing an evaluation model of a voltage sensitive load regulation range:
(2-1) establishing a first variable regulation model in the power system when the voltage sensitive load provides the upward reserve capacity:
(2-1-1) establishing a set Ω^{Δ′} of regulated variables in the power system when the voltage sensitive load provides the upward reserve capacity:
Ω^{Δ′}={ΔPᵢ_{_{G}}_{,t}^{G′},ΔQᵢ_{_{G}}_{,t}^{G′},ΔP_{i,t}^{p f′},ΔU_{i,t}^{p f′},Δδ_{i,t}^{p f′},ΔI_{ij,t}^{p f′},ΔL_{i,t}′}
where ΔPᵢ_{_{G}}_{,t}^{G′} is a variation of the active power of the generator i_{G} at the dispatching time point t when the voltage sensitive load provides the upward reserve capacity, ΔQᵢ_{_{G}}_{,t}^{G′} is a variation of the reactive power of the generator i_{G} at the dispatching time point t when the voltage sensitive load provides the upward reserve capacity, ΔP_{i,t}^{p f′} is a variation of the active power injected at the node i at the dispatching time point t when the voltage sensitive load provides the upward reserve capacity, ΔQ_{i,t}^{p f′} is a variation of the reactive power injected at the node i at the dispatching time point t when the voltage sensitive load provides the upward reserve capacity, ΔU_{i,t}^{p f′} is a variation of the voltage magnitude of the node i at the dispatching time point t when the voltage sensitive load provides the upward reserve capacity, Δδ_{i,t}^{p f′} is a variation of the voltage phase angle of the node i at the dispatching time point t when the voltage sensitive load provides the upward reserve capacity, ΔI_{ij,t}^{p f′} is a variation of the current in the power line between the node i and the node j at the dispatching time point t when the voltage sensitive load provides the upward reserve capacity, and ΔL_{i,t}′ is a variation of the voltage stability index of the node i when the voltage sensitive load provides the upward reserve capacity;
(2-1-2) establishing a constraint among the variations of the active power, the reactive power, the voltage magnitudes and the voltage phase angles injected at respective nodes:
$$[ \begin{matrix}Δ {P}_{t}^{{pf}^{′}} \\ Δ {Q}_{t}^{{pf}^{′}}\end{matrix} ] = {J}^{pf} [ \begin{matrix}{Δδ}_{t}^{{pf}^{′}} \\ Δ {U}_{t}^{{pf}^{′}} \text{/} {U}_{t}^{pf}\end{matrix} ]$$
where ΔPₜ^{p f′} is a column vector constituted by the variations ΔP_{i,t}^{p f′} of the active power injected at respective nodes i at the dispatching time point t when the voltage sensitive load provides the upward reserve capacity, ΔQₜ^{p f′} is a column vector constituted by the variations ΔQ_{i,t}^{p f′} of the reactive power injected at respective nodes i at the dispatching time point t when the voltage sensitive load provides the upward reserve capacity, Δδₜ^{p f′} is a column vector constituted by the variations Δδ_{i,t}^{p f′} of the voltage phase angles of the respective nodes i at the dispatching time point t when the voltage sensitive load provides the upward reserve capacity, ΔUₜ^{p f′} is a column vector constituted by the variations ΔU_{i,t}^{p f′} of the voltage magnitude of the respective nodes i at the dispatching time point t when the voltage sensitive load provides the upward reserve capacity, J^{p f} is a Jacobian matrix of power flow equation, which is obtained from the energy management system of the electro-thermal coupling multi-energy flow system;
(2-1-3) establishing constraints on the variations of the active power and the reactive power injected at respective nodes:
$$Δ {P}_{i , t}^{{pf}^{′}} = - Δ {P}_{i , t}^{{L}^{′}} + ΣΔ {P}_{{i}_{G} , t}^{{G}^{′}} , i ∈ {I}^{B} , t ∈ [ 1 , T ]$$
$$Δ {Q}_{i , t}^{{pf}^{′}} = - Δ {Q}_{i , t}^{{L}^{′}} + ΣΔ {Q}_{{i}_{G} , t}^{{G}^{′}} , i ∈ {I}^{B} , t ∈ [ 1 , T ] \\ - {R}_{{i}_{G}}^{G , d} \leq Δ {P}_{{i}_{G} , t}^{{G}^{′}} \leq {R}_{{i}_{G}}^{G , u} , {i}_{G} ∈ {I}^{G} , t ∈ [ 1 , T ]$$
where ΔP_{i,t}^{L′} is a variation of the active power of the load at the node i at the dispatching time point t when the voltage sensitive load provides the upward reserve capacity, and ΔQ_{i,t}^{L′} is a variation of the reactive power of the load at the node i at the dispatching time point t when the voltage sensitive load provides the upward reserve capacity;
(2-1-4) establishing a constraint equation of the variation of the current in the power line:
$${( {I}_{ij , t}^{pf} )}^{2} + Δ {I}_{ij , t}^{{pf}^{′}} \leq {( {I}_{ij}^{pf , max} )}^{2} , i ∈ {I}^{B} , j ∈ {I}^{B} , t ∈ [ 1 , T ]$$
$$Δ {I}_{ij , t}^{{pf}^{′}} = 2 {I}_{ij , t}^{pf} [ \frac{\partial {I}_{ij , t}^{pf}}{\partial {U}^{pf}} \frac{\partial {I}_{ij , t}^{pf}}{\partial {δ}^{pf}} ] [ \begin{matrix}Δ {U}_{t}^{{pf}^{′}} \\ Δ {δ}_{t}^{{pf}^{′}}\end{matrix} ] , i ∈ {I}^{B} , i ∈ {I}^{G} , t ∈ [ 1 , T ]$$
where U_{p f} is a voltage magnitude,
$$\frac{\partial {I}_{ij , t}^{pf}}{\partial {U}^{pf}}$$
is a sensitivity of I_{ij,t}^{p f} to the voltage magnitude, and is obtained from the energy management system of the electro-thermal coupling multi-energy flow system, δ^{p f} is a voltage phase angle, and
$$\frac{\partial {I}_{ij , t}^{pf}}{\partial {δ}^{pf}}$$
is a sensitivity of I_{ij,t}^{p f} to the voltage phase angle, and is obtained from the energy management system of the electro-thermal coupling multi-energy flow system;
(2-1-5) establishing constraints on the voltage magnitude and the voltage phase angle:
Uᵢ^{p f,min}≤U_{i,t}^{p f}+ΔU_{i,t}^{p f′}≤Uᵢ^{p f,max},i∈I^{B},t∈[1,T]
δᵢ^{p f,min}≤δ_{i,t}^{p f}+Δδ_{i,t}^{p f′}≤δᵢ^{p f,max},i∈I^{B},t∈[1,T]
(2-1-6) establishing constraints on the active power and the reactive power of the generator:
Pᵢ_{_{G}}^{G,min}≤Pᵢ_{_{G}}_{,t}^{G}+ΔPᵢ_{_{G}}_{,t}^{G′}≤Pᵢ_{_{G}}^{G,max},i_{G}∈I^{G},t∈[1,T]
Qᵢ_{_{G}}^{G,min}≤Qᵢ_{_{G}}_{,t}^{G}+ΔQᵢ_{_{G}}_{,t}^{G′}≤Qᵢ_{_{G}}^{G,max},i_{G}∈I^{G},t∈[1,T]
(2-1-7) establishing constraints on the variations of the active power and the reactive power of the load:
$$Δ {P}_{i , t}^{{L}^{′}} = {P}_{i , t}^{B} ( 2 {a}_{i , t}^{p} \frac{Δ {U}_{i , t}^{{pf}^{′}}}{{U}_{N}^{pf}} + {b}_{i , t}^{p} ) , i ∈ {I}^{B} , t ∈ [ 1 , T ]$$
$$Δ {Q}_{i , t}^{{L}^{′}} = {Q}_{i , t}^{B} ( 2 {a}_{i , t}^{q} \frac{Δ {U}_{i , t}^{{pf}^{′}}}{{U}_{N}^{pf}} + {b}_{i , t}^{q} + 2 {Q}_{i , t}^{FC} \frac{Δ {U}_{i , t}^{{pf}^{′}}}{{U}_{N}^{pf}} ) , i ∈ {I}^{B} , t ∈ [ 1 , T ]$$
(2-1-8) establishing a voltage stability index constraint equation:
$${L}_{i , t} + Δ {L}_{i , t}^{′} \leq {L}^{max}$$
$$Δ {L}_{i , t}^{′} = [ \frac{\partial L}{\partial {U}_{t}^{pf}} \frac{\partial L}{\partial {δ}_{t}^{pf}} ] [ \begin{matrix}Δ {U}_{t}^{{pf}^{′}} \\ {Δδ}_{t}^{{pf}^{′}}\end{matrix} ]$$
where
$$\frac{\partial L}{\partial {U}_{t}^{pf}}$$
is a sensitivity of the voltage stability index to the voltage magnitude, and is obtained from the energy management system of the electro-thermal coupling multi-energy flow system;
$$\frac{\partial L}{\partial {δ}_{t}^{pf}}$$
is a sensitivity of the voltage stability index to the voltage phase angle, and is obtained from the energy management system of the electro-thermal coupling multi-energy flow system;
(2-2) establishing a second variable regulation model in the power system when the voltage sensitive load provides the downward reserve capacity:
(2-2-1) establishing a set Ω^{Δ″} of regulated variables in the power system when the voltage sensitive load provides the downward reserve capacity:
Ω^{Δ″}={ΔPᵢ_{_{G}}_{,t}^{G″},ΔQᵢ_{_{G}}_{,t}^{G″},ΔP_{i,t}^{p f″},ΔU_{i,t}^{p f″},Δδ_{i,t}^{p f″},ΔI_{ij,t}^{p f″},ΔL_{i,t}″}
where ΔPᵢ_{_{G}}_{,t}^{G″} is a variation of the active power of the generator i_{G} at the dispatching time point t when the voltage sensitive load provides the downward reserve capacity, ΔQᵢ_{_{G}}_{,t}^{G″} is a variation of the reactive power of the generator i_{G} at the dispatching time point t when the voltage sensitive load provides the downward reserve capacity, ΔP_{i,t}^{p f″} is a variation of the active power injected at the node i at the dispatching time point t when the voltage sensitive load provides the downward reserve capacity, ΔQ_{i,t}^{p f″} is a variation of the reactive power injected at the node i at the dispatching time point t when the voltage sensitive load provides the downward reserve capacity, ΔU_{i,t}^{p f″} is a variation of the voltage magnitude of the node i at the dispatching time point t when the voltage sensitive load provides the downward reserve capacity, Δδ_{i,t}^{p f″} is a variation of the voltage phase angle of the node i at the dispatching time point t when the voltage sensitive load provides the downward reserve capacity, ΔI_{ij,t}^{p f″} is a variation of the current in the power line between the node i and the node j at the dispatching time point t when the voltage sensitive load provides the downward reserve capacity, and ΔL_{i,t}″ is a variation of the voltage stability index of the node i when the voltage sensitive load provides the downward reserve capacity;
(2-2-2) establishing a constraint among the variations of the active power, the reactive power, the voltage magnitudes and the voltage phase angles injected at respective nodes:
$$[ \begin{matrix}Δ {P}_{t}^{{pf}^{″}} \\ Δ {Q}_{t}^{{pf}^{″}}\end{matrix} ] = {J}^{pf} [ \begin{matrix}{Δδ}_{t}^{{pf}^{″}} \\ Δ {U}_{t}^{{pf}^{″}} \text{/} {U}_{t}^{pf}\end{matrix} ]$$
where ΔPₜ^{p f″} is a column vector constituted by the variations ΔP_{i,t}^{p f″} of the active power injected at respective nodes i at the dispatching time point t when the voltage sensitive load provides the downward reserve capacity, ΔQₜ^{p f″} is a column vector constituted by the variations ΔQ_{i,t}^{p f″} of the reactive power injected at respective nodes i at the dispatching time point t when the voltage sensitive load provides the downward reserve capacity, Δδₜ^{p f″} is a column vector constituted by the variations Δδ_{i,t}^{p f″} of the voltage phase angles of the respective nodes i at the dispatching time point t when the voltage sensitive load provides the downward reserve capacity, and ΔUₜ^{p f″} is a column vector constituted by the variations ΔU_{i,t}^{p f″} of the voltage magnitude of the respective nodes i at the dispatching time point t when the voltage sensitive load provides the downward reserve capacity;
(2-2-3) establishing constraints on the variations of the active power and the reactive power injected at respective nodes:
$$Δ {P}_{i , t}^{{pf}^{′}} = - Δ {P}_{i , t}^{{L}^{′}} + ΣΔ {P}_{{i}_{G} , t}^{{G}^{′}} , i ∈ {I}^{B} , t ∈ [ 1 , T ]$$
$$Δ {Q}_{i , t}^{{pf}^{′}} = - Δ {Q}_{i , t}^{{L}^{′}} + ΣΔ {Q}_{{i}_{G} , t}^{{G}^{′}} , i ∈ {I}^{B} , t ∈ [ 1 , T ] \\ - {R}_{{i}_{G}}^{G , d} \leq Δ {P}_{{i}_{G} , t}^{{G}^{′}} \leq {R}_{{i}_{G}}^{G , u} , {i}_{G} ∈ {I}^{G} , t ∈ [ 1 , T ]$$
where ΔP_{i,t}^{L″} is a variation of the active power of the load at the node i at the dispatching time point t when the voltage sensitive load provides the downward reserve capacity, and ΔQ_{i,t}^{L″} is a variation of the reactive power of the load at the node i at the dispatching time point t when the voltage sensitive load provides the downward reserve capacity;
(2-2-4) establishing a constraint on the variation of the current in the power line:
$${( {I}_{ij , t}^{pf} )}^{2} + Δ {I}_{ij , t}^{{pf}^{′}} \leq {( {I}_{ij}^{pf , max} )}^{2} , i ∈ {I}^{B} , j ∈ {I}^{B} , t ∈ [ 1 , T ]$$
$$Δ {I}_{ij , t}^{{pf}^{′}} = 2 {I}_{ij , t}^{pf} [ \frac{\partial {I}_{ij , t}^{pf}}{\partial {U}^{pf}} \frac{\partial {I}_{ij , t}^{pf}}{\partial {δ}^{pf}} ] [ \begin{matrix}Δ {U}_{t}^{{pf}^{′}} \\ Δ {δ}_{t}^{{pf}^{′}}\end{matrix} ] , i ∈ {I}^{B} , i ∈ {I}^{G} , t ∈ [ 1 , T ]$$
(2-2-5) establishing constraints on the voltage magnitude and the voltage phase angle:
Uᵢ^{p f,min}≤U_{i,t}^{p f}+ΔU_{i,t}^{p f″}≤Uᵢ^{p f,max},i∈I^{B},t∈[1,T]
δᵢ^{p f,min}≤δ_{i,t}^{p f}+Δδ_{i,t}^{p f″}≤δᵢ^{p f,max},i∈I^{B},t∈[1,T]
(2-2-6) establishing constraints on the active power and the reactive power of the generator:
Pᵢ_{_{G}}^{G,min}≤Pᵢ_{_{G}}_{,t}^{G}+ΔPᵢ_{_{G}}_{,t}^{G″}≤Pᵢ_{_{G}}^{G,max},i_{G}∈I^{G},t∈[1,T]
Qᵢ_{_{G}}^{G,min}≤Qᵢ_{_{G}}_{,t}^{G}+ΔGᵢ_{_{G}}_{,t}^{G″}≤Qᵢ_{_{G}}^{G,max},i_{G}∈I^{G},t∈[1,T]
(2-2-7) establishing constraints on the variations of the active power and the reactive power of the load:
$$Δ {P}_{i , t}^{{L}^{′}} = {P}_{i , t}^{B} ( 2 {a}_{i , t}^{p} \frac{Δ {U}_{i , t}^{{pf}^{′}}}{{U}_{N}^{pf}} + {b}_{i , t}^{p} ) , i ∈ {I}^{B} , t ∈ [ 1 , T ]$$
$$Δ {Q}_{i , t}^{{L}^{′}} = {Q}_{i , t}^{B} ( 2 {a}_{i , t}^{q} \frac{Δ {U}_{i , t}^{{pf}^{′}}}{{U}_{N}^{pf}} + {b}_{i , t}^{q} + 2 {Q}_{i , t}^{FC} \frac{Δ {U}_{i , t}^{{pf}^{′}}}{{U}_{N}^{pf}} ) , i ∈ {I}^{B} , t ∈ [ 1 , T ]$$
(2-2-8) establishing a voltage stability index constraint equation:
$${L}_{i , t} + Δ {L}_{i , t}^{′} \leq {L}^{max}$$
$$Δ {L}_{i , t}^{′} = [ \frac{\partial L}{\partial {U}_{t}^{pf}} \frac{\partial L}{\partial {δ}_{t}^{pf}} ] [ \begin{matrix}Δ {U}_{t}^{{pf}^{′}} \\ {Δδ}_{t}^{{pf}^{′}}\end{matrix} ]$$
(3) establishing an optimization objective of power system dispatch:
min F^{G}(Pₜ^{G},rₜ^{G,u},rₜ^{G,d})+F^{p}(Pₜ^{wd},Pₜ^{lc})−F^{B}(Pₜ^{L})
where Pₜ^{G} is a column vector constituted by the active power Pᵢ_{_{G}}_{,t}^{G} of all the generators in the power system, rₜ^{G,u} is a column vector constituted by the upward reserve capacities rᵢ_{_{G}}_{,t}^{G,u} provided by all the generators in the power system, rₜ^{G,d} is a column vector constituted by the downward reserve capacities rᵢ_{_{G}}_{,t}^{G,d} provided by all the generators in the power system, F^{G}(Pₜ^{G},rₜ^{G,u},rₜ^{G,d}) is the cost of providing the active power and reserve capacities by all the generators in the power system, Pₜ^{wd} is a column vector constituted by the active power Pᵢ_{_{W}}_{,t}^{wd} abandoned by all the wind farms in the power system, Pₜ^{lc} is a column vector constituted by the active power P_{i,t}^{lc} of all the removed loads in the power system, F^{P}(Pₜ^{wd},Pₜ^{lc}) is the cost of abandoned wind farms and the removed loads in the power system, Pₜ^{L} is a column vector constituted by the active power P_{i,t}^{L} of all the electrical loads in the power system, and F^{B} (Pₜ^{L}) is sales revenue of the power system; and
(4) constructing an optimized power system dispatching model considering the voltage sensitive load reserve by the ground state operating point model of the power system established in step (1), the evaluation model of the voltage sensitive load regulation range established in step (2) and the optimization objective of power system dispatch established in step (3), solving the optimized power system dispatching model by an interior point method to obtain dispatching parameters of the power system, including the active power Pᵢ_{_{G}}_{,t}^{G} of the generator i_{G}, the reactive power Qᵢ_{_{G}}_{,t}^{G} of the generator i_{G}, the active power P_{i,t}^{L} of the load at the node i, and the reactive power Q_{i,t}^{L} of the load at the node i, to complete power system dispatching considering voltage sensitive load reserve.

2. The power system dispatching method considering voltage sensitive load reserve according to claim 1, wherein the optimized power system dispatching model is solved by an Ipopt solver.

3. A power system dispatching device considering voltage sensitive load reserve, comprising:
a processor;
a memory having stored therein a computer program that, when executed by the processor, causes the processor to perform the method according to claim 1.

4. A non-transitory computer-readable storage medium having stored therein instructions that, when executed by a processor, causes the processor to perform the method according to claim 1.
